(19) United States
(12) Patent Application Publication
(10) Pub. No.: US 2026/0064071 A1
(43) Pub. Date: Mar. 5, 2026

(54) IMAGE FORMING APPARATUS

(71) Applicant: CANON KABUSHIKI KAISHA, Tokyo (JP)

(72) Inventors: Kazuya Yamazaki, Shizuoka (JP); Takateru Ohkubo, Shizuoka (JP); Koji Miwa, Shizuoka (JP); Koichi Sekimizu, Shiga (JP)

(21) Appl. No.: 19/307,212

(22) Filed: Aug. 22, 2025

(30) Foreign Application Priority Data
Sep. 4, 2024 (JP) 2024-152770

(51) Int. Cl. G03G 21/10; G01V 8/12; G03G 15/16; G03G 21/12

(52) U.S. Cl. CPC G03G 21/105; G01V 8/12; G03G 15/161; G03G 21/12; G03G 2215/1661

(57) ABSTRACT

An image forming apparatus includes a driven member, a driving source, a first rotatable member, a second rotatable member, a detecting portion capable of detecting that the second rotatable member is in a second phase, and a restricting portion. The first rotatable member and the second rotatable member are rotated in a first phase when a rotational load torque of the driven member is a first torque and are rotated in the second phase when the rotational load torque of the driven member is a second torque. In a case where the phase changes from the first phase to the second phase, even when the rotational load torque of the driven member lowers from the second torque toward the first torque, the restricting portion restricts that the phase returns from the second phase to the first phase.

### BACKGROUND

### Field of the Technology

The present disclosure relates to an image forming apparatus, such as a printer, a copying machine, a facsimile machine, or a multi-function machine having a plurality of functions of these functions, using an electrophotographic type or an electrostatic recording type.

### Description of the Related Art

In the image forming apparatus such as the printer using the electrophotographic type, waste toner remaining on an image bearing member after a toner image is transferred from the image bearing member onto a transfer-receiving member is removed from the image bearing member by a cleaning means and is collected in a waste toner collecting container.

The waste toner collecting container is provided with a waste toner conveying screw as a waste toner conveying member in order to convey the waste toner to a predetermined position in the waste toner collecting container and to level the waste toner in the waste toner collecting container in some instances. Further, between the waste toner conveying screw and a driving motor for rotationally driving this screw, a torque detecting means for detecting a rotational load torque of the waste toner conveying screw is provided in some instances. By providing this torque detecting means, the waste toner in the waste toner collecting container is increased in amount by an increase in number of sheets passed through the image forming apparatus, and in the case where the rotational load torque of the waste toner conveying screw becomes a predetermined value or more (overload state), this state can be detected. On the basis of a detection result of this torque detecting means, exchange of the waste toner collecting container is prompted to a user by notifying the user of that the waste toner collecting container becomes a full state or is close to the full state, breakage of the driving motor or the waste toner conveying screw and overflow of the waste toner from the waste toner collecting container are prevented.

In Japanese Patent No. 6729176, a torque detecting means having a constitution in which two rotatable members are coaxially provided and in which a phase difference between the two rotatable members changing due to a magnitude of the rotational load torque is detected and then the rotational load torque is detected on the basis of the phase difference is disclosed.

### SUMMARY

According to an aspect of the present disclosure, there is provided an image forming apparatus comprising: a driven member; a driving source configured to generate a driving force for rotationally driving the driven member; a first rotatable member configured to be rotated by input of the driving force from the driving source thereto; a second rotatable member provided coaxially with the first rotatable member and configured to transmit the driving force toward the driven member by being rotated through transmission thereto the driving force from the driving source by the first rotatable member, the second rotatable member being rotatable relative to the first rotatable member so that a phase which is a position of the second rotatable member relative to the first rotatable member with respect to a rotational direction of the first rotatable member changes from a first phase toward a second phase different from the first phase; detecting means capable of detecting that the second rotatable member is in the second phase; and restricting means configured to restrict the phase, wherein the first rotatable member and the second rotatable member are configured so as to change the phase with a change in rotational load torque of the driven member from a first torque to a second torque larger than the first torque so that the first rotatable member and the second rotatable member are rotated in a state in which the second rotatable member is in the first phase in a case where the rotational load torque of the driven member is the first torque and so that the first rotatable member and the second rotatable member are rotated in a state in which the second rotatable member is in the second phase in a case where the rotational load torque of the driven member is the second torque, and wherein in a case where the phase changes from the first phase to the second phase, even when the rotational load torque of the driven member lowers from the second torque toward the first torque, the restricting means restricts that the phase returns from the second phase to the first phase.

Features of the present disclosure will become apparent from the following description of embodiments with reference to the attached drawings. The following description of embodiments are described by way of example.

### BRIEF DESCRIPTION OF THE DRAWINGS

FIG. 1 is a sectional view showing a whole constitution of a printer.

FIG. 2 is a sectional view showing the printer in a state in which a door thereof is open.

FIG. 3 is a sectional view showing the printer in a state in which a fixing device is moved.

FIG. 4 is a sectional view showing the printer in a state in which a transfer unit and a tray unit are pulled out.

FIG. 5 is a sectional view showing the printer in a state in which the transfer unit is solely pulled out.

FIG. 6 is a perspective view showing a whole constitution of the transfer unit.

FIG. 7 is a perspective view of the transfer unit for illustrating a waste toner conveying path.

FIG. 8 is a perspective view showing the waste toner conveying path and a drive connection mechanism.

FIG. 9 is a perspective view of the drive connection mechanism in an embodiment 1.

FIG. 10 is an exploded perspective view of the drive connection mechanism in the embodiment 1.

Parts (a) to (b) of FIG. 11 are a perspective view and a front view, respectively, of a movable gear in the embodiment 1, and parts (c) and (d) of FIG. 11 are a perspective view and a front view, respectively, of a fixed gear in the embodiment 1.

Parts (a), (b), and (c) of FIG. 12 are schematic views for illustrating an operation of the drive connection mechanism in the embodiment 1.

Parts (a) and (b) of FIG. 13 are perspective views for illustrating an operation of a torque detecting mechanism in the embodiment 1.

Parts (a) and (b) of FIG. 14 are sectional views for illustrating the operation of the torque detecting mechanism in the embodiment 1.

FIG. 15 is a perspective view of a drive connection mechanism in an embodiment 2.

FIG. 16 is an exploded perspective view of the drive connection mechanism in the embodiment 2.

FIG. 17A is a perspective view of a torque detecting mechanism in the embodiment 2.

FIG. 17B is a perspective view of the torque detecting mechanism in the embodiment 2.

Parts (a) and (b) of FIG. 18 are sectional views of a driving piece in the embodiment 2.

Parts (a) and (b) of FIG. 19 are sectional views of a driven piece in the embodiment 2.

Parts (a) and (b) of FIG. 20 are sectional views for illustrating an operation of the torque detecting mechanism in the embodiment 2.

FIG. 21 is a perspective view showing a whole constitution of a torque detecting mechanism in an embodiment 3.

FIG. 22 is an exploded perspective view of a drive connection mechanism in the embodiment 3.

Parts (a) and (b) of FIG. 23 are perspective views of a first rotatable member in the embodiment 3.

Parts (a) and (b) of FIG. 24 are perspective views of a second rotatable member in the embodiment 3.

FIG. 25 is a sectional view for illustrating an operation of the torque detecting mechanism in the embodiment 3.

FIG. 26 is a perspective view of a torsion spring in the embodiment 3.

FIG. 27A is a front view of the torque detecting mechanism for illustrating the operation of the torque detecting mechanism in the embodiment 3.

FIG. 27B is a front view of the torque detecting mechanism for illustrating the operation of the torque detecting mechanism in the embodiment 3.

Parts (a), (b), and (c) of FIG. 28 are schematic views for illustrating the operation of the torque detecting mechanism in the embodiment 3.

FIG. 29 is a block diagram showing a schematic control constitution of the printer.

### DESCRIPTION OF THE EMBODIMENTS

In the following, an image forming apparatus according to the present disclosure will be described specifically.

### Embodiment 1

### <Whole Constitution of Image Forming Apparatus>

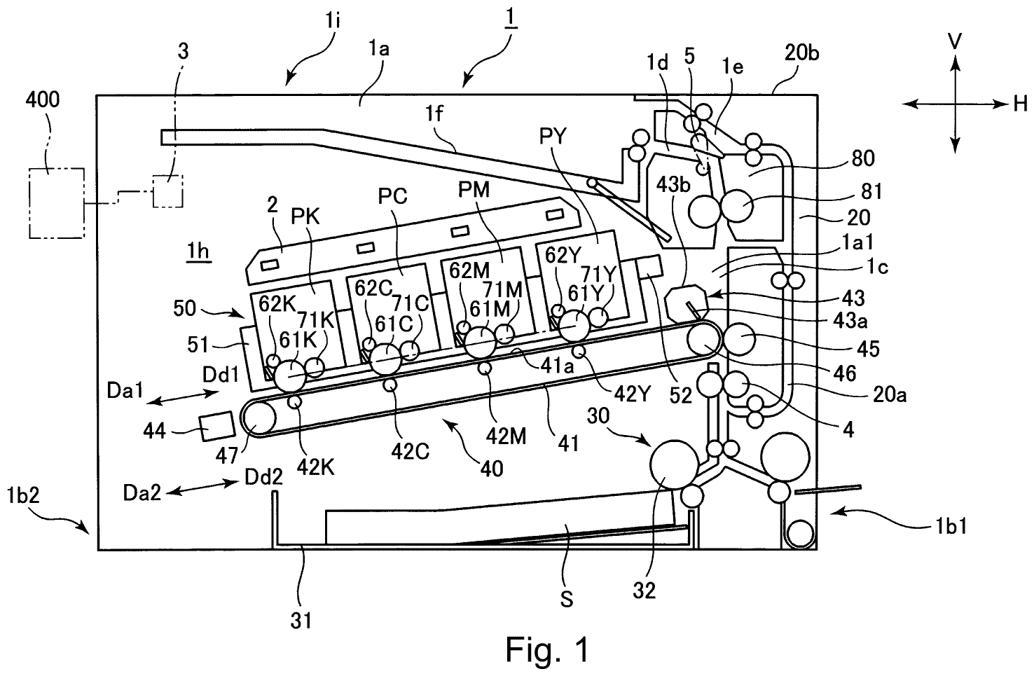

A whole constitutions of the image forming apparatus of this embodiment will be described using FIG. 1. FIG. 1 is a sectional view showing the whole constitution of the image forming apparatus of this embodiment. In this embodiment, the image forming apparatus is a tandem-type color laser beam printer (hereinafter, simply referred to as a “printer”) 1 employing an intermediary transfer type in which a full-color image is capable of being formed on a sheet S by using an electrophotographic type.

Incidentally, as regards the printer 1 and elements thereof, a right side in FIG. 1 is a “front (front surface)” side, and a left side in FIG. 1 is a “rear (rear side)” side. Further, as regards the printer 1 and the elements thereof, in the case where the printer 1 is viewed from the front side, a left side (the front side on the drawing sheet of FIG. 1) is a “left” side, and a right side (the rear side on the drawing sheet of FIG. 1) is a “right” side. A left-right direction connecting these left side and right side is substantially parallel to a rotational axis direction of a photosensitive drum 61 described later and is substantially parallel to a rotational axis direction of each of stretching rollers for an intermediary transfer belt 41 described later. Further, in this embodiment, the printer 1 is disposed so that a front-rear direction and a left-right direction are substantially parallel to a horizontal direction H, and is used for image formation. Further, as regards the printer 1 and the elements thereof, up (upper) and drum (lower) refer to up (upper) and down (lower) in a gravitational direction (vertical direction) V, but do not mean only immediately above (on) and immediately below (under), and include an upper side and a lower side than a horizontal surface (plane) passing through a noting position or a noting element. Further, as the sheet S, typically, paper is used, and therefore, the sheet S is referred to as the paper in some instances, but the surface S is not limited to the paper, and as the sheet S, a material, other than the paper, such as a plastic sheet, or a sheet formed of a material including the material other than the paper can also be used.

The printer 1 includes an apparatus main assembly (casing) la, a scanner 2 which is an exposure device as an exposure means, a controller (control circuit) 3 as a control means, and a door 20 which is an openable/closable member which is openable and closable relative to the apparatus main assembly 1a. Further, the printer 1 includes a sheet feeding portion 30, a transfer unit 40 which is a transfer device (intermediary transfer device) as a transfer means, a tray unit 50 as a moving unit (supporting unit), and a fixing device 80 as a fixing means. A portion including the apparatus main assembly 1a and the door 20 can also be referred to as a main frame ii. The main frame ii includes an outer casing portion of the printer 1.

The apparatus main assembly 1a accommodates the scanner 2, the controller 3, the sheet feeding portion 30, the transfer unit 40, the tray unit 50, and the fixing device 80.

The sheet feeding portion 30 includes a stacking tray 31 on which sheets S which are sheet-like recording materials (transfer materials, recording media, sheets) are stacked, and a feeding roller 32 as a feeding member. The stacking tray 31 is capable of being pulled out in a drive (front side) from the apparatus main assembly 1a to the door 20. Further, to the stacking tray 31 pulled out from the apparatus main assembly 1a, sheets S can be supplemented.

The tray unit 50 includes a tray 51 as a supporting member (drawer), and four cartridges (image forming portions) PY, PM, PC, and PK. The tray 51 includes a tray handle 52. Each of the cartridges PY, PM, PC, and PK is detachably (removably) mounted to the tray 51.

In this embodiment, each of the cartridges PY, PM, PC, and PK is independently detachably mountable to the tray 51. The four cartridges PY, PM, PC, and PK form images (toner images) of yellow (Y), magenta (M), cyan (C), and black (K), respectively.

The four cartridges PY, PM, PC, and PK accommodate toner as developers of yellow (Y), magenta (M), cyan (C) and black (K), respectively. In this embodiment, as each of the developers, a one-component developer is used. The cartridges PY, PM, PC, and PK have substantially the same constitution except that the colors of the toner accommodated therein are different from each other. As regards elements having identical or corresponding functions or constitutions provided for the respective colors of yellow, magenta, cyan, and black, these elements are collectively described in some instances by omitting suffixes Y, M, C, and K, of reference numerals or symbols, each showing the element for the associated one of the colors. The tray unit 50 can be said to include the plurality of the cartridges P, and the tray 51 to which the plurality of the cartridges P are detachably mounted.

In this embodiment, the tray unit 50 includes the plurality of photosensitive drums 61 (61Y, 61M, 61C, 61K), a plurality of charging rollers 62 (62Y, 62M, 62C, 62K), and a plurality of developing rollers 71 (71Y, 71M, 71C, 71K). Specifically, the tray unit 50 includes four photosensitive drums 61, four charging rollers 62, and four developing rollers 71. The photosensitive drum 61 is a rotatable drum-type (cylindrical) photosensitive member (electrophotographic photosensitive member) as a first image bearing member. The charging roller 62 is a roller-type charging member as a charging means. The developing roller 71 is a developer carrying member (developing member) for carrying and conveying, toward the photosensitive drum 61, toner accommodated in a toner accommodating member provided in the tray 51 or the cartridge P. A rotational axis direction of the photosensitive drum 61, a rotational axis direction of the developing roller 71, and a rotational axis direction of the charging roller 62 are substantially parallel to each other.

A portion (including the photosensitive drum 61, the charging roller 62, and the developing roller 71) forming an image of the associated color can also be referred to as a station. The cartridge PK for black is mounted to a black station. The cartridge PC for cyan is mounted to a cyan station. The cartridge PM for magenta is mounted to a magenta station. The cartridge PY for yellow is mounted to a yellow station.

The photosensitive drum 61, the charging roller 62, and the developing roller 71 may only be required to be provided in either one of the cartridge P or the tray 51. In this embodiment, the cartridge P includes the photosensitive drum 61, the charging roller 62, and the developing roller 71. Incidentally, the tray unit 50 may include a drum cleaning portion (drum cleaning device) as a photosensitive member cleaning means for removing the toner from the associated one of the photosensitive drums 61. That is, the tray unit 50 may include a plurality of drum cleaning portions for cleaning surfaces of the photosensitive drums 61, respectively. The drum cleaning portion can be provided to either one of the cartridge P and the tray 51. For example, the drum cleaning portion scrapes off the toner from the surface of the rotating photosensitive drum 61 by a cleaning blade as a cleaning member contacting the surface of the photosensitive drum 61, and accommodates the toner in a collected toner accommodating portion provided to the tray 51 or the cartridge P.

The transfer unit 40 includes the intermediary transfer belt (hereinafter, simply referred to as a “belt”) 41, primary transfer rollers 42 (42Y, 42M, 42C, 42K), a cleaning portion 43, a driving roller 46, and a tension roller (driven roller, follower roller) 47. The belt 41 is an intermediary transfer member constituted by an endless belt as a second image bearing member. The primary transfer roller 42 is a roller-type primary transfer member as a primary transfer means. The cleaning portion (belt cleaning device) 43 is a cleaning means for cleaning a surface of the belt 41. The driving roller 46 and the tension roller 47 are stretching rollers for stretching the belt 41. The driving roller 46 drives the belt 41. Further, the tension roller 47 imparts a predetermined tension to the belt 41. By the driving roller 46 and the tension roller 47, a primary transfer surface 41a which is a surface of the belt 41 onto which toner images are transferred from the photosensitive drums 61Y, 61M, 61C, and 61K is formed.

In this embodiment, the printer 1 includes an optical sensor 44 for detecting the toner image transferred on the belt 41. In this embodiment, the belt 41 is disposed below the photosensitive drums 61Y, 61M, 61C, and 61K. The belt 41 is contactable to the photosensitive drum 61 so that a primary transfer portion is formed between the belt 41 and the photosensitive drum 61. Further, the printer 1 includes a secondary transfer roller 45 in a position where the secondary transfer roller 45 opposes the driving roller 46 through the belt 41. The secondary transfer roller 45 contacts the belt 41 so that a secondary transfer portion is formed between the belt 41 and the secondary transfer roller 45. A rotational axis direction of the primary transfer roller 42, a rotational axis direction of the driving roller 46, a rotational axis direction of the tension roller 47, and a rotational axis direction of the secondary transfer roller 45 are substantially parallel to each other. On a front side of the secondary transfer portion with respect to the conveying direction of the sheet S, a registration roller pair 4 as a synchronous conveying member is provided.

The fixing device 80 includes a fixing portion 81 and a flapper 5. When an image forming operation for forming an image on the sheet S, the fixing device 80 is in a use position. The fixing device 80 is accommodated in an inside portion of (inside) the apparatus main assembly 1a in a state in which the fixing device 80 is in the use position. Further, the fixing device 80 is constituted so as to heat the sheet S in the state in which the fixing device 80 is in the use position. In this embodiment, the fixing portion 81 includes a heating portion (heating roller) including a heater, and a pressing portion (pressing roller) for nipping and conveying the sheet S in cooperation with the heating portion.

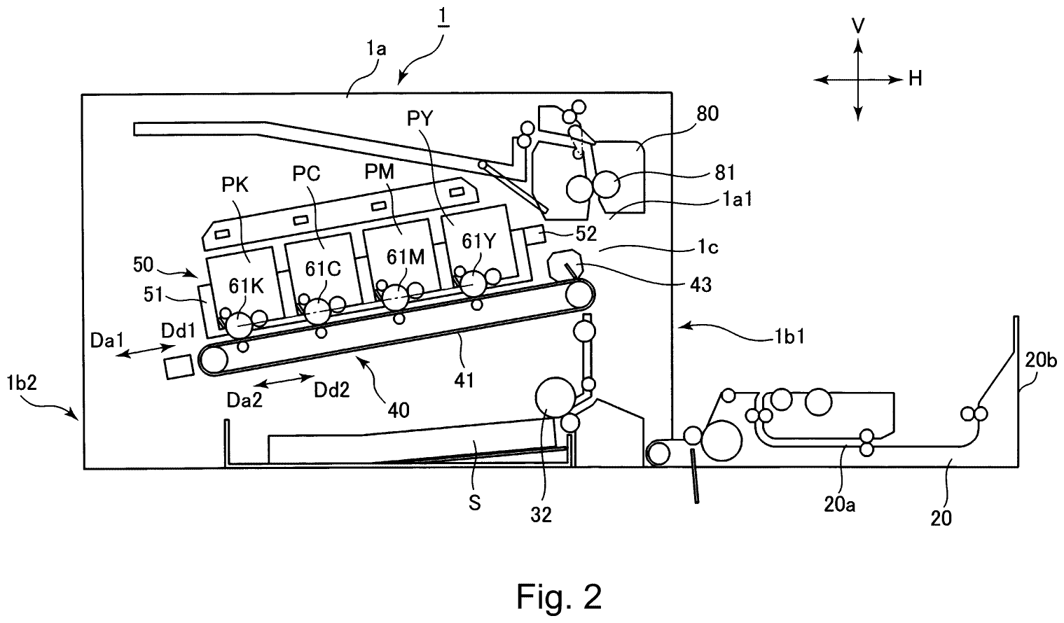

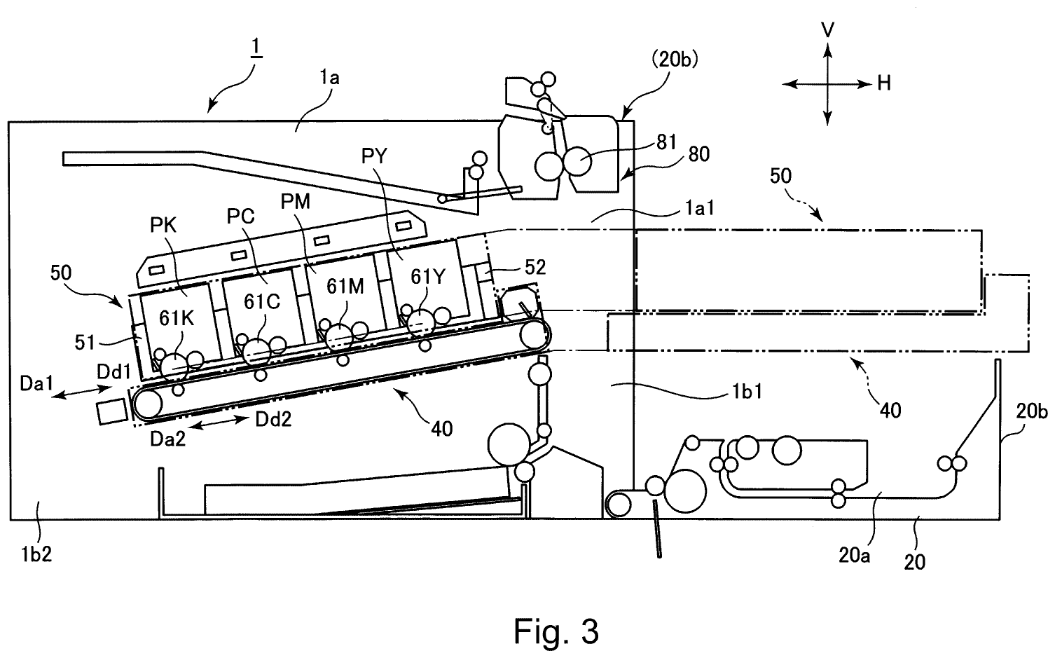

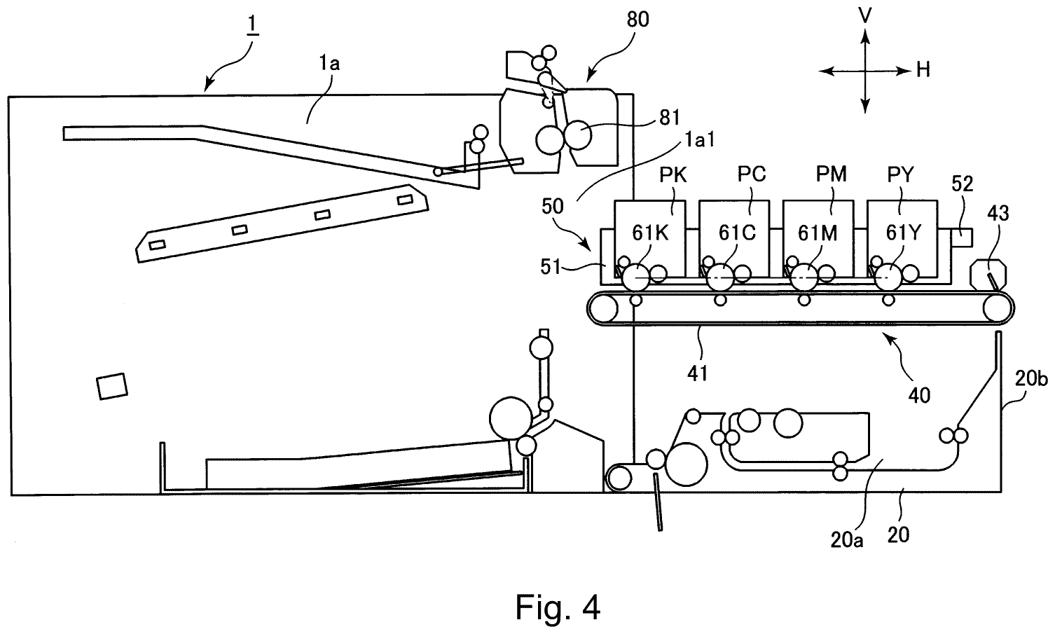

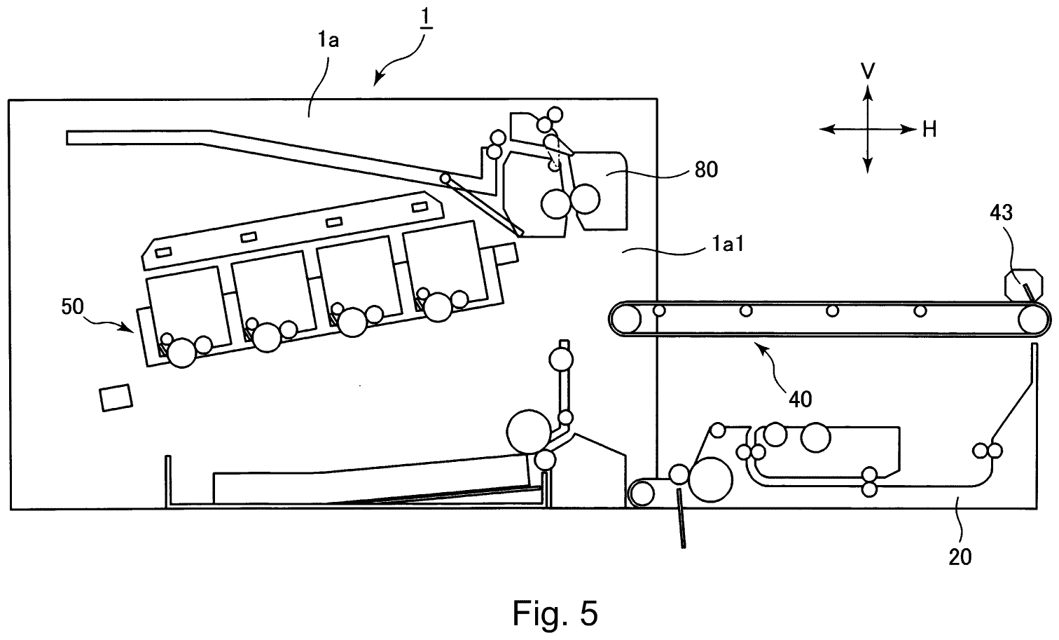

Movement of the transfer unit 40 and the tray unit 50 will be described by using FIGS. 1 to 5. FIG. 2 is a sectional view showing the printer 1 in a state in which the door 20 is open. FIG. 3 is a sectional view showing the printer 1 in a state in which the fixing device 80 is moved. FIG. 4 is a sectional view showing the printer 1 in a state in which the transfer unit 40 and the tray unit 50 are pulled out from the apparatus main assembly 1a. FIG. 5 is a sectional view showing the printer 1 in a state in which the transfer unit 40 is solely pulled out from the apparatus main assembly 1a.

The transfer unit 40 and the tray unit 50 are movable from an inside to an outside of the apparatus main assembly 1a. With respect to the horizontal direction H (front-rear direction), the apparatus main assembly 1a includes a first end portion 1b1 provided with a main assembly opening 1a1 which is an opening, and a second end portion 1b2 on a side opposite from the first end portion 1b1. The tray unit 50 is movable, through the main assembly opening 1a1, between a first inside position on the inside of the apparatus main assembly 1a and a first outside position on the outside of the apparatus main assembly 1a. The transfer unit 40 is movable, through the main assembly opening 1a1, between a second inside position on the inside of the apparatus main assembly 1a and a second outside position on the outside of the apparatus main assembly 1a. The main assembly opening 1a1 may also be constituted by including an opening through which the tray unit 50 passes and an opening through which the transfer unit 40 passes. Incidentally, when the transfer unit 40 moves from the second inside position to the second outside position, at least the belt 41 is moved and at least a part of the belt 41 projects from the apparatus main assembly 1a toward the outside of the apparatus main assembly 1a.

A direction in which tray unit 50 moves from the first inside position to the first outside position is referred to as a tray demounting direction Dd1, and a direction opposite to the tray demounting direction Dd1 is referred to as a tray mounting (attaching) direction Da1. The tray demounting direction Dd1 can be said as a direction from the second end portion 1b2 toward the first end portion 1b1. A direction in which the transfer unit 40 moves from the second inside position to the second outside position is referred to as a transfer (unit) demounting direction Dd2, and a direction opposite to the transfer demounting direction Dd2 is referred to as a transfer (unit) mounting (attaching) direction Da2. With respect to the transfer demounting direction Dd2, the driving roller 46 is positioned on a side downstream of the tension roller 47. The transfer demounting direction Dd2 can be said as a direction from the second end portion 1b2 toward the first end portion 1b1. Each of the tray demounting direction Dd1 and the tray mounting direction Da1 is a direction crossing (preferably substantially perpendicular to) the rotational axis direction of the photosensitive drum 61. Each of the transfer demounting direction Dd2 and the transfer mounting direction Da2 is a direction crossing (preferably substantially perpendicular to) the rotational axis direction of the driving roller 46. The rotational axis direction of the driving roller 46 is substantially parallel to the rotational axis direction of the photosensitive drum 61. In the horizontal direction H (front-rear direction), on one end side of the apparatus main assembly 1a (on a side where the first end portion 1b1 is disposed), the fixing device 80 is disposed.

The door 20 mounted to the apparatus main assembly 1a is movable between a closed position and an open position.

As shown in FIG. 1, in a state in which the door 20 is in the closed position (closed state of the door 20), the door 20 covers the main assembly opening 1a1. As shown in FIG. 2, in a state in which the door 20 is in the open position (open state of the door 20), the main assembly opening 1a1 is exposed.

As shown in FIG. 1, in the state in which the door 20 is in the closed position, the door 20 covers the fixing device 80 mounted to the apparatus main assembly 1a. Specifically, in the state in which the door 20 is in the closed position, an upper cover portion 20b of the door 20 is positioned above the fixing device 80. The upper cover portion 20b of the door 20 has a function as a part of an outer casing portion of the printer 1.

The door 20 is capable of moving to the open position and the closed position in a state in which the fixing device 80 is supported by the apparatus main assembly 1a. In other words, the door 20 moves from the closed position to the open position so as to be separated from the fixing device 80 supported by the apparatus main assembly 1a. Accordingly, as shown in FIG. 2, in the state in which the door 20 is in the open position, the door 20 is separated from the fixing device 80 supported by the apparatus main assembly 1a.

As described above, the fixing device 80 is movable from a state shown in FIG. 2 to a state shown in FIG. 3 so that the main assembly opening 1a1 is widely exposed. As shown in FIG. 3, in a state in which the door 20 and the fixing device 80 are moved, the transfer unit 40 and the tray unit 50 are movable from the inside to the outside of the apparatus main assembly 1a through the main assembly opening 1a1, and become a state shown in FIG. 4 after being moved.

As shown in FIG. 4, in a state in which the tray unit 50 is moved to the outside of the apparatus main assembly 1a, demounting of each of the cartridges PY, PM, PC, and PK from the tray 51 and mounting of each of the cartridges PY, PM, PC, and PK to the tray 51 are permitted. By this, the cartridges PY, PM, PC, and PK can be exchanged with new cartridges PY, PM, PC, and PK, respectively. In this embodiment, the cartridge P is detachably mountable to the tray 51 with respect to a direction crossing (preferably substantially perpendicular to) the rotational axis direction of the photosensitive drum 61.

Each of the cartridges PY, PM, PC, and PK is demounted from the tray 51 by being moved relative to the tray 51 in a direction in which each cartridge is moved away from the transfer unit 40. In other words, each of the cartridges PY, PM, PC, and PK is demounted from the tray 51 by being moved toward a side opposite from the transfer unit 40 with respect to the tray 51. In this embodiment, the transfer unit 40 is disposed below the tray unit 50. Accordingly, each of the cartridges PY, PM, PC, and PK is demounted from the tray 51 by being moved upward relative to the tray 51.

Further, as shown in FIG. 5, the transfer unit 40 can be demounted from the apparatus main assembly 1a independently of the tray unit 50. By this, the transfer unit 40 can be exchanged with a new transfer unit 40.

### <Image Forming Operation>

An image forming operation of the printer 1 will be described by using FIG. 1. A controller 3 of the printer 1 starts the image forming operation for forming the image on the sheet S on the basis of image information (image signal) received from an external host device 400. The external host device 400 is, for example, a personal computer, an image reader, a facsimile machine, or the like.

When the image forming operation is performed, the fixing device 80 is positioned in the use position, the tray unit 50 is positioned in the first inside position, the transfer unit 40 is positioned in the second inside position, and the door 20 is positioned in the closed position. In a state in which the transfer unit 40 is in the second inside position, the belt 41 is contactable to the photosensitive drums 61Y, 61M, 61C, and 61K. At this time, the tray unit 50 is positioned above the transfer unit 40.

When the image forming operation is started, the photosensitive drum 61 is rotationally driven, and to the charging roller 62, a charging voltage is applied. The photosensitive drum 61 is rotationally driven in a clockwise direction in FIG. 1. Further, the belt 41 is rotationally driven. The belt 41 is rotated (circulated and moved) in a counterclockwise direction in FIG. 1 by that the driving roller 46 is rotationally driven by a driving motor 5 (FIG. 29). The surface of the photosensitive drum 61 is electrically charged uniformly to a predetermined polarity (negative polarity in this embodiment) and a predetermined potential by the charging roller 62. The charged surface of the photosensitive drum 61 is irradiated with laser light, corresponding to the image information, from the scanner 2, so that the surface of the photosensitive drum 61 is exposed to the laser light. By this, on the surface of the photosensitive drum 61, an electrostatic latent image (electrostatic image) corresponding to the image information is formed.

The developing roller 71 carries thereon the toner in the toner accommodating portion provided in the cartridge P in this embodiment. To the developing roller 71, a developing voltage is applied, so that the toner is supplied from the developing roller 71 to the surface of the photosensitive drum 61 depending on the electrostatic latent image formed on the surface of the photosensitive drum 61.

By this, the electrostatic latent image on the surface of the photosensitive drum 61 is developed (visualized), so that a toner image (toner picture, developer image) is formed on the surface of the photosensitive drum 61. In this embodiment, on an exposure portion of the photosensitive drum 61 lowered in absolute value of an electric charge by that the surface of the photosensitive drum 61 is exposed to the laser light after being charged uniformly, toner charged to the same polarity (negative polarity in this embodiment) as a charge polarity of the photosensitive drum 61 is deposited. In this embodiment, a normal charge polarity of the toner, which is a principal charge polarity of the toner during development is the negative polarity. In this embodiment, the developing roller 71 develops the electrostatic latent image in a state in which the developing roller 71 contacts the photosensitive drum 61.

However, the printer 1 may have a constitution in which the developing roller 71 develops the electrostatic latent image in a state in which there is a gap between the developing roller 71 and the photosensitive drum 61.

For example, during full-color image formation, toner images of the colors of yellow, magenta, cyan, and black are formed on the photosensitive drums 61Y, 61M, 61C, and 61K, respectively.

Incidentally, in this embodiment, in a state in which the tray unit 50 is in the first inside position, the developing roller 71 is movable between a contact position where the developing roller 71 contacts the photosensitive drum 61 and a separation position where the developing roller 71 is separated from the photosensitive drum 61. Specifically, by a switching device (not shown) provided in the apparatus main assembly 1a, a state in which the developing roller 71 is in the contact position and a state in which the developing roller 71 is in the separation position are switched therebetween. By this, in a state in which the image forming operation is not performed, the developing roller 71 can be kept separated from the photosensitive drum 61.

Further, the printer 1 is capable of performing monochromatic print (printing) in a state in which the developing roller 71 and the photosensitive drum 61 of the cartridge PK are in contact with each other and in which the developing roller 71 and the photosensitive drum 61 of each of the cartridges PY, PM, and PK are in separation from each other. Further, the printer 1 is capable of performing full-color print (printing) in a state in which the photosensitive drums 61 of the cartridges PY, PM, PC, and PK and the belt 41 are in contact with each other.

The toner image formed on the photosensitive drum 61 is transferred (primarily) transferred onto the rotating belt 41 as a transfer-receiving member in the primary transfer portion by the action of the primary transfer roller 42. During the primary transfer, to the primary transfer roller 42, a primary transfer voltage of the opposite polarity to the normal charge polarity of the toner is applied. The toner image transferred on the belt 41 is conveyed toward a secondary transfer portion formed by the belt 41 and the secondary transfer roller 45, by rotation of the belt 41. For example, during the full-color image formation, the toner images of the colors of yellow, magenta, cyan, and black formed on the photosensitive drums 61Y, 61M, 61C, and 61K are successively transferred superposedly in the same image forming region on the belt 41.

On the other hand, in the apparatus main assembly 1a, a conveying path (first path, first conveying path) lc along which the sheet S directed toward the fixing device 80 passes is formed. Further, on the door 20, a double-side conveying path (second path, second conveying path) 20a along which the sheet S moving toward the fixing device 80 passes is formed. The door 20 covers the conveying path 1c in the closed state. As shown in FIG. 2, the door 20 is opened, so that the conveying path 1c and the double-side conveying path 20a are exposed. In the sheet feeding portion 30, from the sheets S stacked on the stacking tray 31, at a predetermined timing, one sheet S is separated and fed by the feeding roller 32. This sheet S passes through the conveying path 1c and is conveyed toward the secondary transfer portion and the fixing device 80. That is, the sheet S fed from the stacking tray 31 by the feeding roller 32 is conveyed to the registration roller pair 4. This sheet 4 is conveyed toward the secondary transfer portion by being timed to the toner images on the belt 41, by the registration roller pair 4.

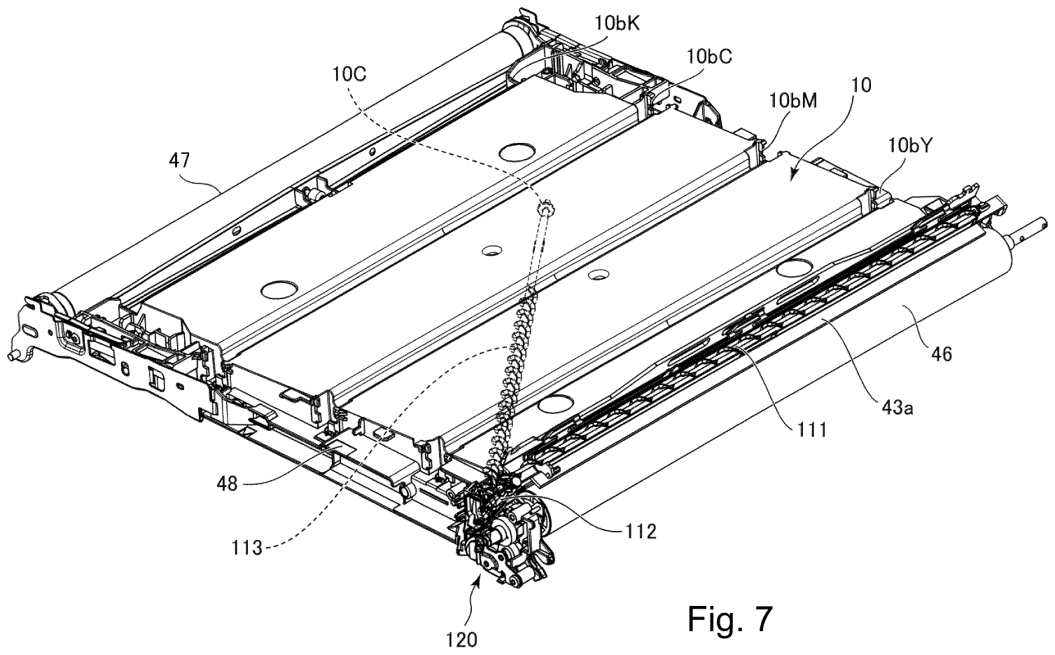

The toner images formed on the belt 41 are transferred (secondarily transferred) in the secondary transfer portion onto the sheet S nipped and conveyed by the belt 41 and the secondary transfer roller 45 by the action of the secondary transfer roller 45. During the secondary transfer, to the secondary transfer roller 45, a secondary transfer voltage of the opposite polarity to the normal charge polarity of the toner is applied. Toner (waste toner, remaining toner) remaining on the belt 41 without being transferred onto the sheet S is removed and collected from on the belt 41 by the cleaning portion 43. The cleaning portion 43 includes a cleaning blade 43a as a cleaning member contacting the surface of the belt 41 and a cleaning container 43b forming a collected toner accommodating portion. The cleaning blade 43a is provided in the cleaning container 43b. The cleaning portion 43 scrapes off the toner from the surface of the rotating belt 41 by the cleaning blade 43a, and accommodates the toner in the cleaning container 43b. The toner removed from the surface of the belt 41 by the cleaning portion 43 is collected (accumulated) as residual (waste) toner by being conveyed from the cleaning portion 43 toward a waste toner collecting container 10 (FIG. 7) described later.

The sheet S on which the toner images are transferred in the secondary transfer portion is conveyed toward the fixing device 80. The fixing portion 81 of the fixing device 80 heats and presses the sheet S on which unfixed toner images are carried, and fixes (melts, sticks) the toner images on the sheet S. The sheet S on which the toner images are fixed is conveyed toward a flapper 5 as a path switching portion.

The flapper 5 is movable to a discharge position where the sheet S passed through the fixing device 80 is guided toward a discharge path 1d, and a reverse roller where the sheet S is guided toward a reverse path 1e. In the case where one-side print (printing) in which the image is formed on one surface (side) of the sheet S is performed, the sheet S is guided to the discharge path 1d by the flapper 5 and is discharged (outputted) to a discharge tray if formed at an upper portion of the apparatus main assembly 1a. On the other hand, in the case where double-side print (printing) in which images are printed (formed) on a first surface (side) (front surface (side)) and a second surface (side) (rear surface (side)) of the sheet S, the sheet S on which first surface the toner image is fixed is guided to the reverse path 1e by the flapper 5. This sheet S is reversed in conveying direction thereof after being guided to the reverse path 1e. Then, the sheet S passes through the double-side conveying path 20a formed on the door 20 and is conveyed toward the secondary transfer portion, and then, the toner image is transferred onto the second surface. Thereafter, this sheet S passes through the fixing device 80 and is guided to the discharge path 1d by the flapper 5, and then is discharged to the discharge tray if of the apparatus main assembly 1a.

In this embodiment, an image forming portion 1h for forming the toner image on the sheet S is constituted by the image forming portions P, the transfer unit 40, the secondary transfer roller 45, and the like. Further, in this embodiment, the cleaning portion 43 of the belt 41 is an example of the cleaning portion for collecting the toner in the image forming portion 1h. Further, in this embodiment, the waste toner collecting container 10 (FIG. 7), for accommodating the toner collected from the belt 41, described later is an example of a waste toner collecting container 10 for accommodating toner collected by the cleaning portion (waste toner collected in the apparatus main assembly).

### <Control Constitution>

FIG. 29 is a block diagram showing a schematic control constitution of the printer 1. The printer 1 includes the controller 3 as a control means for integrally controlling the printer 1. The controller 3 is constituted by including a CPU 3a as an arithmetic processing means (arithmetic processing portion), a memory 3b as a storing means (storing portion) and an input/output circuit (not shown) as an input/output means (input/output portion). The memory 3b is constituted by including a ROM, a RAM, and an EEPROM. In the ROM, a control program and an application program which are executed by the CPU 3a are stored. The RAM functions as a work area for executing processing of the control program. The EEPROM holds data such as various settings desired to be held even when a power source of the printer 1 is turned off. The CPU 3a carries out control of the printer 1 in accordance with the program stored in the memory 3b (ROM).

To the controller 3, for example, a torque detecting mechanism 100 described later, an operating portion 4, the driving motor 5, the scanner 2, a high-voltage power source 6, and the like are connected. The torque detecting mechanism 100 is capable of detecting that a rotational load torque of a waste toner conveying screw 113 provided to the waste toner collecting container 10 becomes a predetermined value or more (overload state) as described later. The torque detecting mechanism 100 inputs, to the controller 3, a signal indicating a detection result thereof. The operating portion 4 is constituted by including a display portion for displaying information to a user (operator) by control of the controller 3 and an input portion for inputting, to the controller 3, in formation such as various settings on the basis of an operation by the user. The operating portion 3 may be constituted by including a touch panel or the like having a function of the display portion and a function of the input portion. In this case, the operating portion 4 performs screen display to the user and reception of touch input by the user. The driving motor 5 is a driving source for generating a driving force for rotationally driving the belt 41 (driving roller 46). Incidentally, the printer 1 may also be provided with another driving motor as a driving source for another driven portion such as the photosensitive drum 61 or the fixing device 80. Further, the driving source for the driving roller 46 as the driven portion and at least a part of the driving source for another driven portion such as the photosensitive drum 61 or the fixing device 80 may also be commonized. The high-voltage power source 6 applies predetermined voltages to the charging roller 62, the developing roller 71, the primary transfer rollers 42, the secondary transfer roller 45, and the like. For each of application objects, a separate high-voltage power source 6 may be provided, and commonality of high-voltage power sources 6 for a plurality of application objects of the above-described application objects may also be realized. Further, to the controller 3, the external host device 400 is connected. The controller 3 is capable of executing the image forming operation by controlling the respective portions of the printer 1 on the basis of a print instruction or image information inputted from the external host device 400. Further, the controller 3 is capable of executing processing of detection and notification of a near full state or a full state of the waste toner collecting container 10 as described later.

### <Waste Toner Conveying Path>

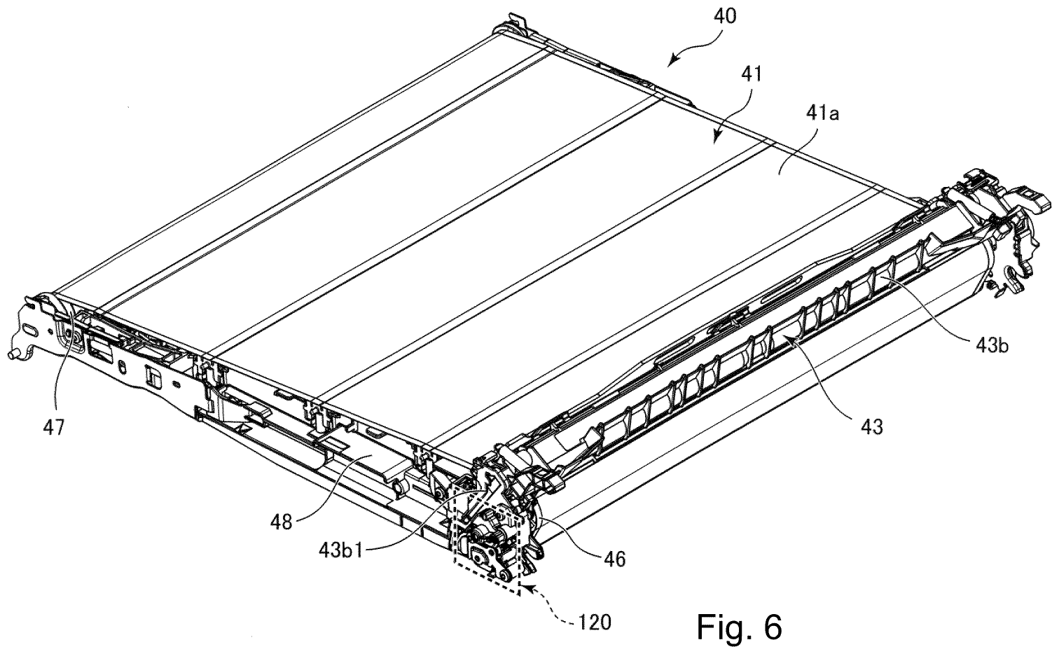

A waste toner conveying path will be described by using FIGS. 6 to 8. FIG. 6 is a perspective view showing a whole constitution of the transfer unit 40 in this embodiment. FIG. 7 is a perspective view of the transfer unit 40 for illustrating the waste toner conveying path in this embodiment, in which a state such that the belt 41, the cleaning container 43b of the cleaning portion 43, and the like are removed from the transfer unit 40 is shown.

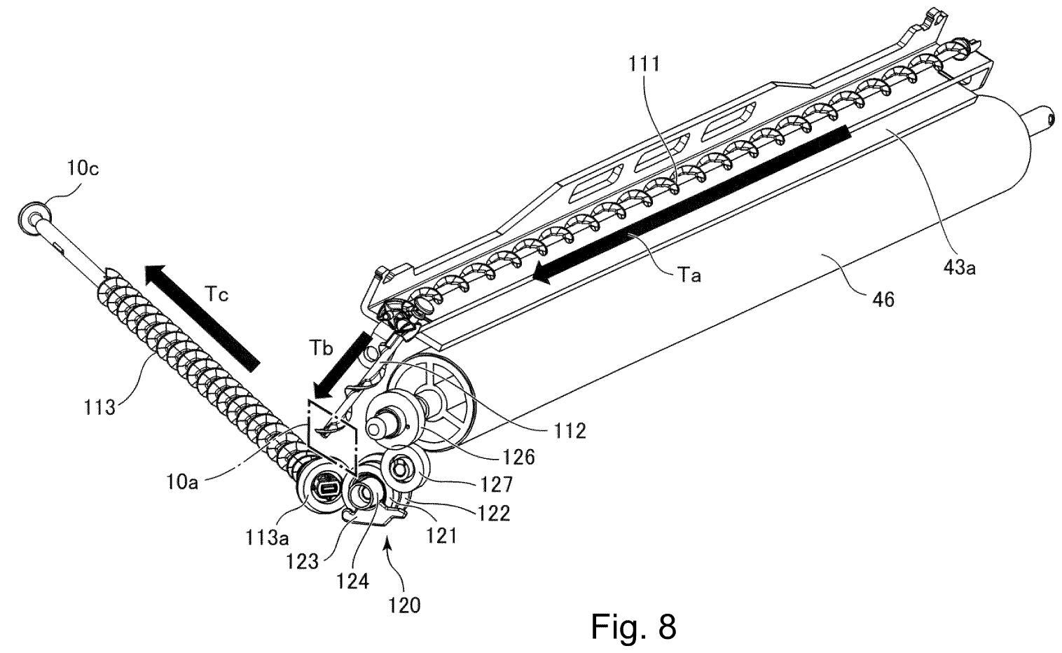

FIG. 8 is a perspective view showing the waste toner conveying path and drive connection mechanism in this embodiment.

The cleaning portion 43 includes the cleaning container 43b and the cleaning blade 43a provided inside the cleaning container 43b. The cleaning blade 43a extends along a widthwise direction (left-right direction) which is a direction substantially perpendicular to a surface movement direction of the belt 41. The cleaning blade 43a is disposed so as to contact the driving roller 46 through the belt 41. Further, the cleaning blade 43a is disposed so as to contact the surface (outer peripheral surface) of the belt 41 with respect to a counterdirection to the movement direction of the belt 41. That is, the cleaning blade 43a is contacted to the surface of the belt 41 in an attitude such that a free end portion thereof with respect to a widthwise (short) direction substantially perpendicular to a longitudinal direction disposed along the widthwise direction of the belt 41 is directed toward an upstream side of the surface movement direction of the belt 41. The cleaning blade 43a scrapes off the toner from the surface of the rotating belt 41 and accommodates the toner as the waste toner inside the cleaning container 43b. Here, the cleaning blade 43a is contacted to the belt 41 at a predetermined angle, so that the toner can be moved from the surface of the belt 41 by movement of the belt 41 in one direction. In this embodiment, a driving force is not inputted from the driving source to the driving roller 46 so that the belt 41 and the driving roller 46 are reversely rotated.

The transfer unit 40 includes a transfer frame 48 as frame for supporting the driving roller 46, the tension roller 47, the primary transfer rollers 42, and the like. In this embodiment, inside this transfer frame 48, a space (region) in which the waste toner is capable of being accommodated is provided. That is, in this embodiment, it can be said that the transfer frame 48 also functions as the waste toner collecting container 10. However, the waste toner collecting container 10 may also be constituted separately from the transfer frame 48 and may be mounted to the transfer frame 48. That is, in this embodiment, the waste toner collecting container 10 is provided in a region constituted by an inner peripheral surface of the belt 41. In this embodiment, in the apparatus main assembly 1a, the waste toner collecting container 10 is disposed so that a bottom thereof crosses a gravitational direction. Further, in this embodiment, the waste toner collecting container 10 is constituted in a substantially rectangular shape in the case where the waste toner collecting container 10 is viewed in a direction substantially perpendicular to the primary transfer surface 41a of the belt 41. In a portion of an upper surface of the waste toner collecting container 10 opposing the primary transfer rollers 42Y, 42M, 42C, and 42K, groove portions 10bY, 10bM, 10bC, and 10bK are formed, respectively, along a rotational axis direction (left-right direction) of each primary transfer roller 42. By this, the waste toner collecting container 10 does not restrict rotation of each primary transfer roller 42. The driving roller 46, the tension roller 47, and each primary transfer roller 42 are rotatably supported through a supporting portion provided to the transfer frame 48.

The cleaning portion 43 includes therein a cleaning screw 111 and an intermediary screw 112 which are as waste toner conveying members for conveying the waste toner removed from the belt 41 by the cleaning blade 43a. The cleaning screw 111 includes a rotation shaft disposed along the widthwise direction (left-right direction) of the belt 41 and a helical conveying portion formed along an axial direction of this rotation shaft. The cleaning screw 111 is drive-connected to the driving roller 46 by a drive connection portion (not shown), and is rotated by receiving the driving force inputted from the driving motor 5 to the driving roller 46. Further, the cleaning screw 111 conveys the waste toner in an arrow Ta direction (direction from a right side toward a left side) in FIG. 8 by being rotated. The intermediary screw 112 includes a rotation shaft disposed along a direction (direction crossing the horizontal direction) crossing a rotational axis direction of the cleaning screw 111 and a helical conveying portion formed along an axial direction of this rotation shaft. One end portion (upper side end portion) of the intermediary screw 112 with respect to the rotational axis direction is disposed close to one end portion (left side end portion) of the cleaning screw 111 with respect to the rotational axis direction. The intermediary screw 112 is drive-connected to the cleaning screw 111 in this one end portion and is rotated by receiving the driving force from the cleaning screw 111. Further, the intermediary screw 112 conveys the waste toner in an arrow Tb direction (direction from an upper side toward a lower side) in FIG. 8 by being rotated. The other end portion of the intermediary screw 112 with respect to the rotational axis direction is disposed close to one end portion (end portion on a left side and on a left side and on a front side) of a waste toner conveying screw 113 described later with respect to a rotational axis direction. The intermediary screw 112 is provided inside a conveying path 43b1 (FIG. 6) provided in a left-side end portion of the cleaning container 43b. This conveying path 43b1 is connected to an inlet port 10a (FIG. 8) of the waste toner collecting container 10, and through this inlet port 10a, an inside of the waste toner collecting container 10 and an inside of the conveying path 43b1 communicate with each other. The waste toner conveyed in the arrow Ta direction in FIG. 8 by the cleaning screw 111 is conveyed in the arrow Tb direction in FIG. 8 by the intermediary screw 112, so that the waste toner flows into the waste toner collecting container 10 through the inlet port 10a.

Further, inside the waste toner collecting container 10, the waste toner conveying screw 113 as a waste toner conveying member is provided. The waste toner conveying screw 113 includes a rotation shaft and a helical conveying portion formed along an axial direction of this rotation shaft. One end portion (end portion on a left side and on a front side) of the waste toner conveying screw 113 with respect to a rotational axis direction is disposed close to the inlet port 10a of the waste toner collecting container 10. The other end portion of the waste toner conveying screw 113 with respect to the rotational axis direction is rotatably supported by a bearing portion 10c provided inside the waste toner collecting container 10. The waste toner conveying screw 113 is drive-connected to the driving roller 46 by a drive connection mechanism 120 described later, and is rotated through this drive connection mechanism 120 by receiving the driving force inputted from the driving motor 5 to the driving roller 46. Then, by the rotation, the waste toner conveying screw 113 conveys the waste toner, flowed into the waste toner collecting container 10 through the inlet port 10a, in an arrow Tc direction in FIG. 8.

In the case where the waste toner conveying screw 113 is viewed in a direction substantially perpendicular to the primary transfer surface 41a of the belt 41, the rotational axis direction of the waste toner conveying screw 113 is a direction which is not perpendicular to the movement direction (front-rear direction) of the primary transfer surface 41a and the widthwise direction (left-right direction) of the belt 41 and which crosses these directions. The waste toner flowed into the waste toner collecting container 10 through the inlet port 10a is conveyed by the waste toner conveying screw 113 toward a substantially central portion of the waste toner collecting container 10 in the case where the waste toner collecting container 10 is viewed in a direction substantially perpendicular to the primary transfer surface 41a of the belt 41 as shown by the arrow Tc in FIG. 8. An end portion of the helical conveying portion of the waste toner conveying screw 113 on a side opposite from the inlet port 10a with respect to the rotational axis direction of the waste toner conveying screw 113 is disposed in a substantially central portion of the waste toner collecting container 10. Accordingly, the waste toner conveyed by the waste toner conveying screw 113 is gradually charged while being diffused in a concentric circular shape from the substantially central portion of the waste toner collecting container 10.

Thus, the toner removed from the belt 41 by the cleaning blade 43a is conveyed toward the waste toner collecting container 10 by the cleaning screw 111 provided inside the cleaning container 43b and by the intermediary screw 112. Further, the waste toner collecting container 10 is provided with the waste toner conveying screw 113 for conveying the waste toner toward the substantially central portion of the waste toner collecting container 10, and the waste toner is accumulated inside the waste toner collecting container 10. The waste toner conveying screw 113 as a driven member is rotated by input of the driving force from the driving motor 5 as the driving source through the drive connection mechanism 120 described later. Further, when an amount of the waste toner is increased later. Further, when an amount of the waste toner is increased by an increase in number of sheets subjected to printing by the printer 1, the waste toner is conveyed radially from the central portion toward an outside of the waste toner collecting container 10.

In this embodiment, in the case where the amount of the waste toner accumulated in the waste toner collecting container 10 becomes a predetermined amount or more (typically, in the case where the waste toner amount exceeds the predetermined amount), a state thereof is detected and warning about the state is notified to the user. In this embodiment, this state is referred to as a “near full state”, and the warning notified to the user in the case where the waste toner amount became this state is referred to as “near full state notification”. In this embodiment, even after the near full state notification is made the printer 1 is capable of continuing the print operation until the amount of the waste toner collected in the waste toner collecting container 10 reaches a predetermined amount (second predetermined amount). Then, in the case where the amount of the waste toner collected in the waste toner collecting container 10 reached the predetermined amount (second predetermined amount) in which the waste toner is capable of being accumulated in the waste toner collecting container 10, a state thereof is detected, and warning about the state is notified to the user. In this embodiment, this state is referred to as a “full state”, and the warning notified to the user in the case where the waste toner amount became this state is referred to as “full state notification”. In this embodiment, when the full state notification is made, the operation of the printer 1 is stopped (the print operation is prohibited).

With an increasing amount of the waste toner in the waste toner collecting container 10, a density of the waste toner becomes higher. For that reason, a resisting force generated when the waste toner is conveyed by the waste toner conveying screw 113 becomes large, so that a rotational load torque of the waste toner conveying screw 113 increases.

In this embodiment, in the case where the rotational load torque of the waste toner conveying screw 113 becomes a predetermined value or more (overload state) (typically, in the case where the rotational load torque exceeds the predetermined value), the near full state of the waste toner collecting container 10 is detected by the torque detecting mechanism 100 (FIG. 13 and the like) described later. Then, on the basis of a detection result of this torque detecting mechanism 100, the controller 3 notifies the user of warning by display or the like in a screen of the operating portion 4 provided to the printer 1. This warning can be made by display of a message prompting preparation of exchange of the waste toner collecting container 10 or the like. Further, in place of or in addition to the operating portion 4, similar warning can be notified in a display portion or the like of the external host device 400 connected to the printer 1.

Further, in this embodiment, even after the near full state of the waste toner collecting container 10 is detected, the print operation can be continued until the amount of the waste toner collected in the waste toner collecting container 10 reached the predetermined amount and becomes the full state. In this embodiment, the controller calculates an amount of the toner, consumed by the print operation, on the basis of the image information from the near full state to the full state. That is, by counting the number of pixels of a print image, it is possible to calculate the amount of the toner consumed by the print operation. Then, in the case where the amount of the toner consumed by the print operation from detection of the near full state reached the predetermined amount, the controller 3 notifies the user of the warning by display or the like in the screen of the operating portion 4 provided to the printer 1. This warning can be made by display of a message or the like prompting exchange of the waste toner collecting container 10. However, a means for detecting the amount of the waste toner collected in the waste toner collecting container 10 after the near full state is detected is not limited to the above-described method. For example, methods in which the number of sheets subjected to the printing is counted, in which a detecting means for detecting the full state is provided, and in which a rotation time or a number of rotations of the driving roller 46 (transfer unit 40) is counted may be used. Further, in place of or in addition to the operating portion 4, in the display portion or the like of the external host device 400 connected to the printer, similar warning can be notified.

### <Drive Connection Mechanism>

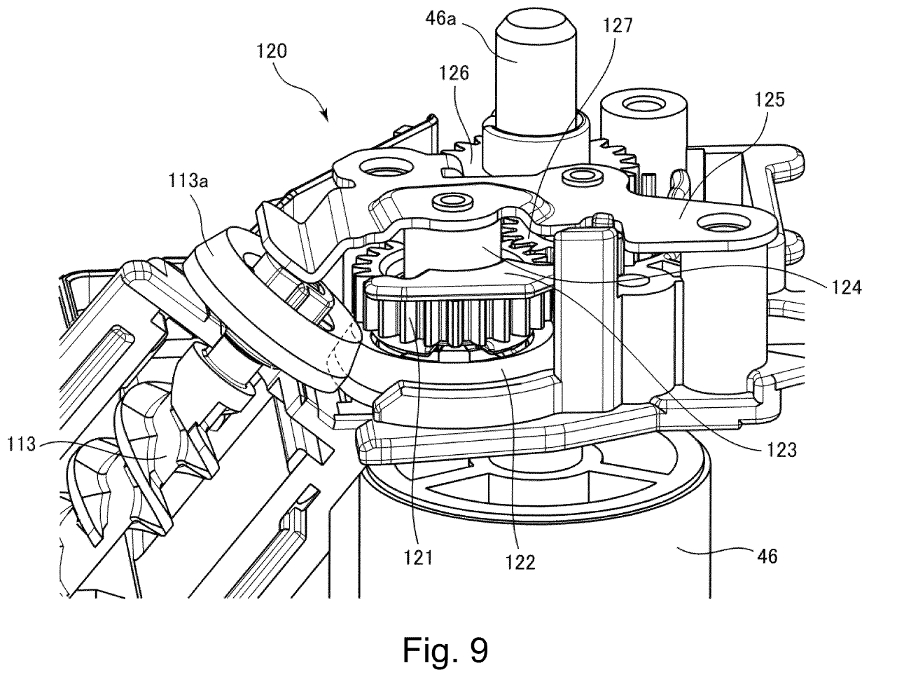

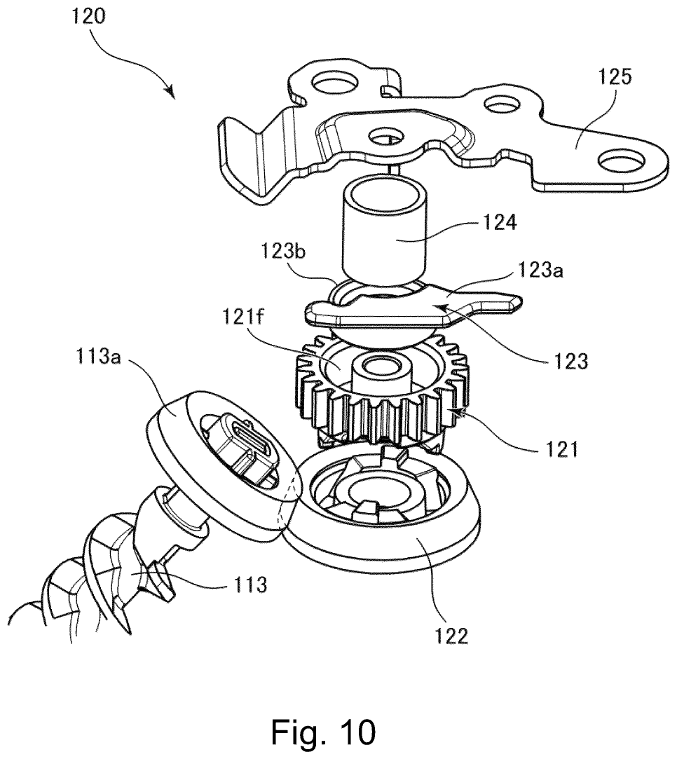

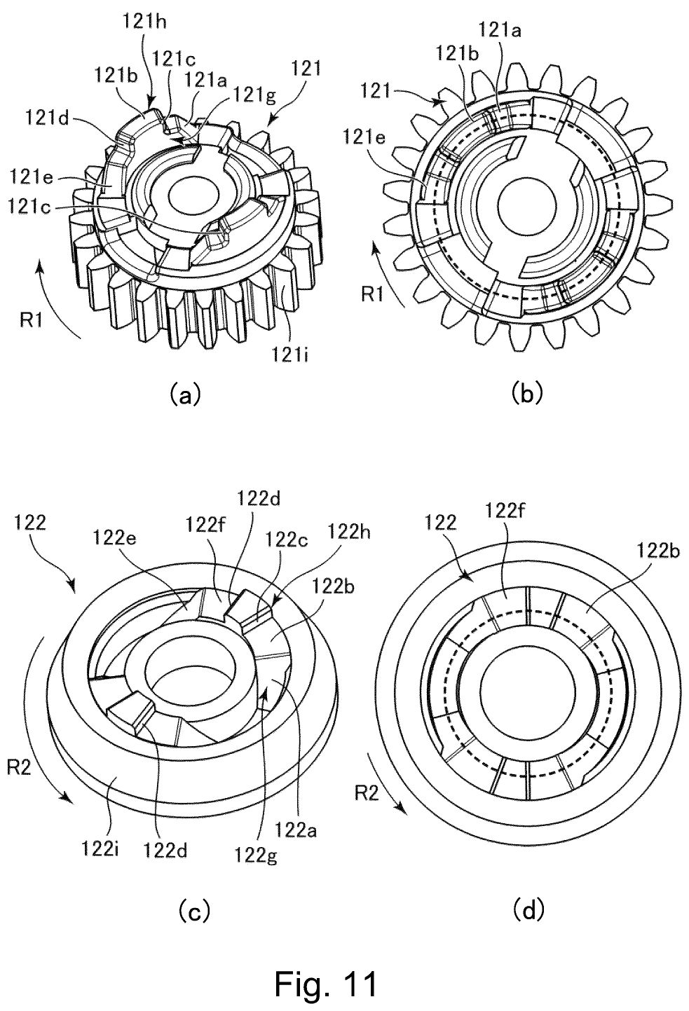

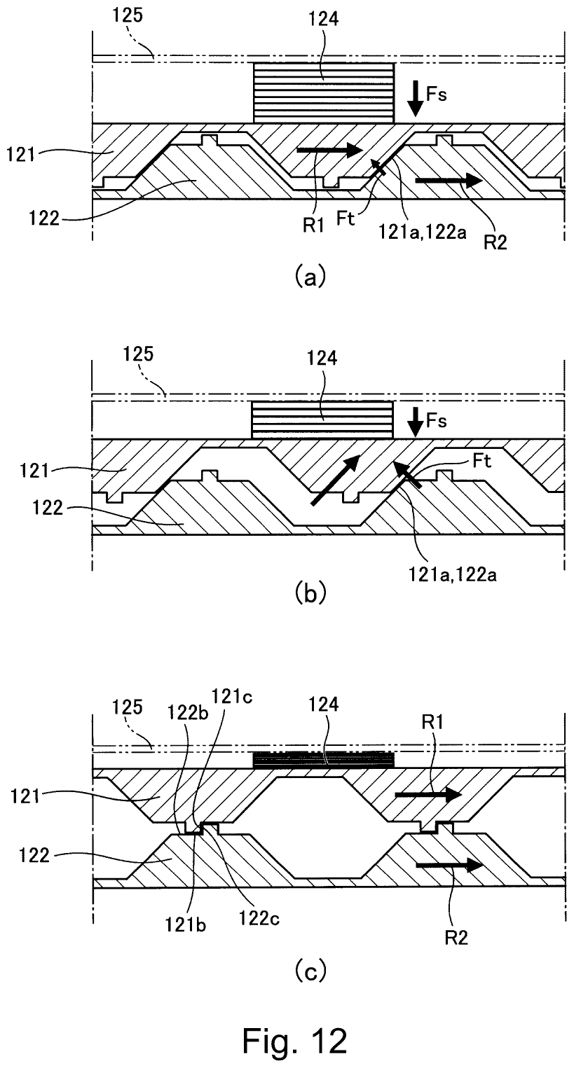

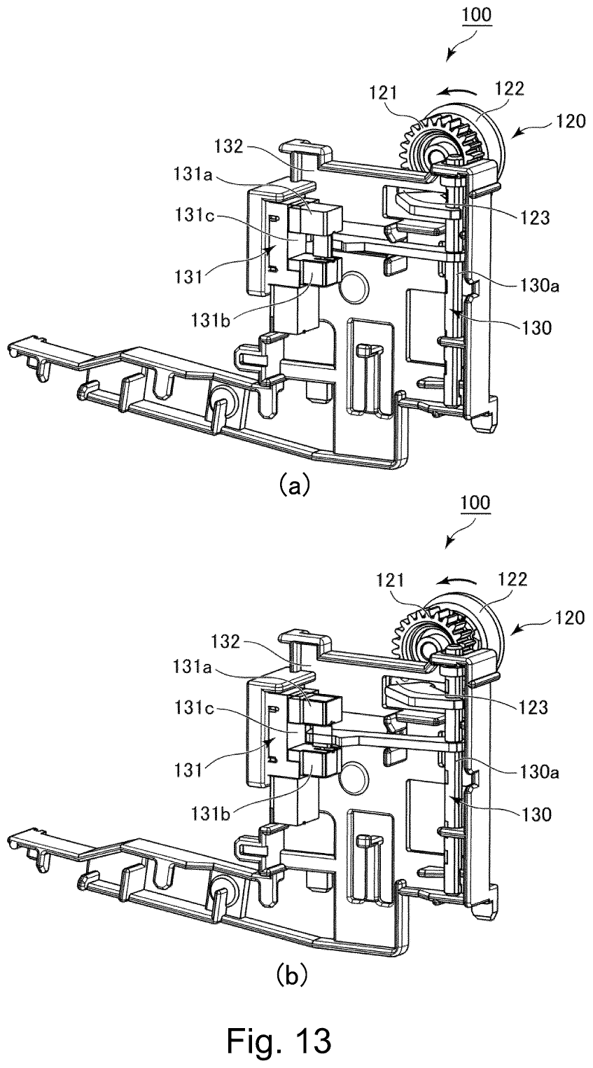

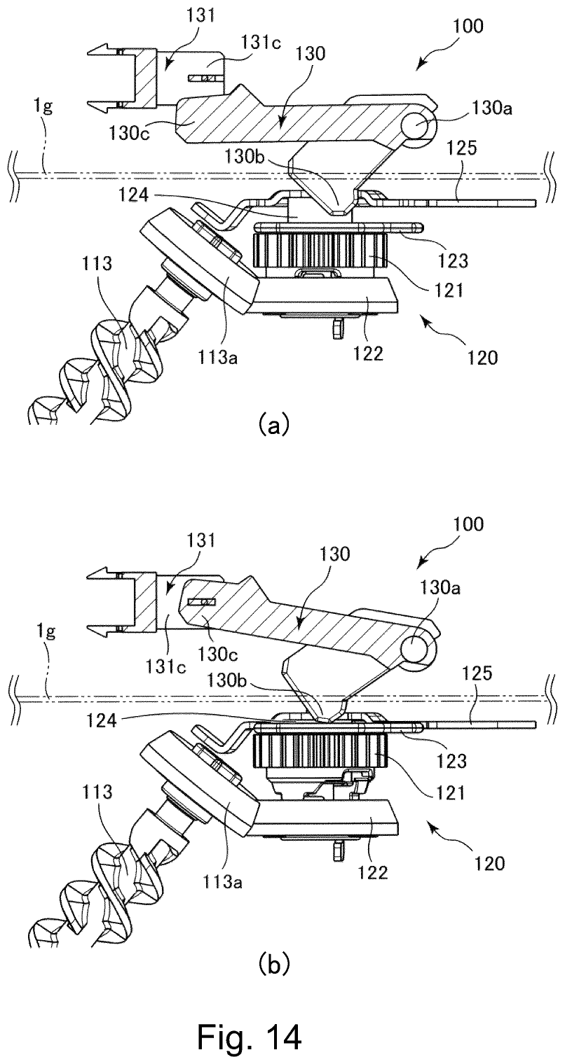

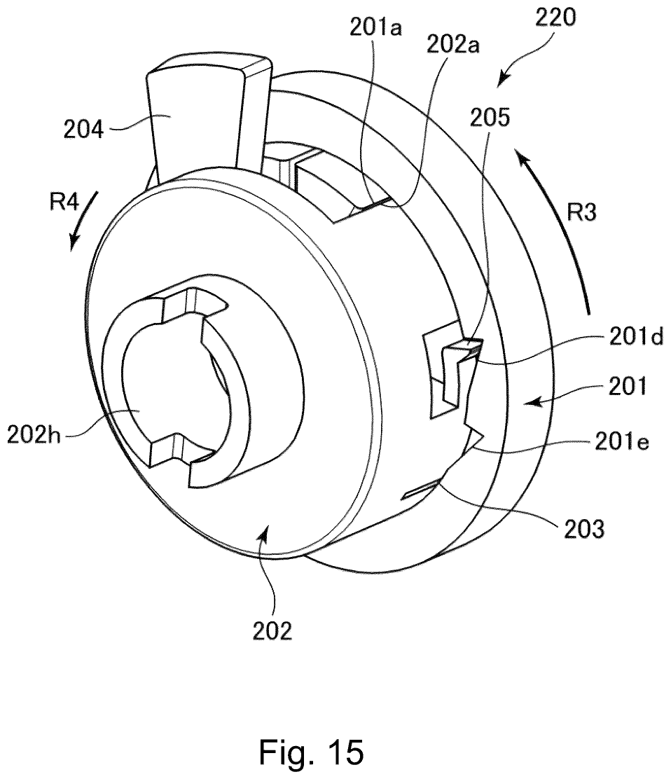

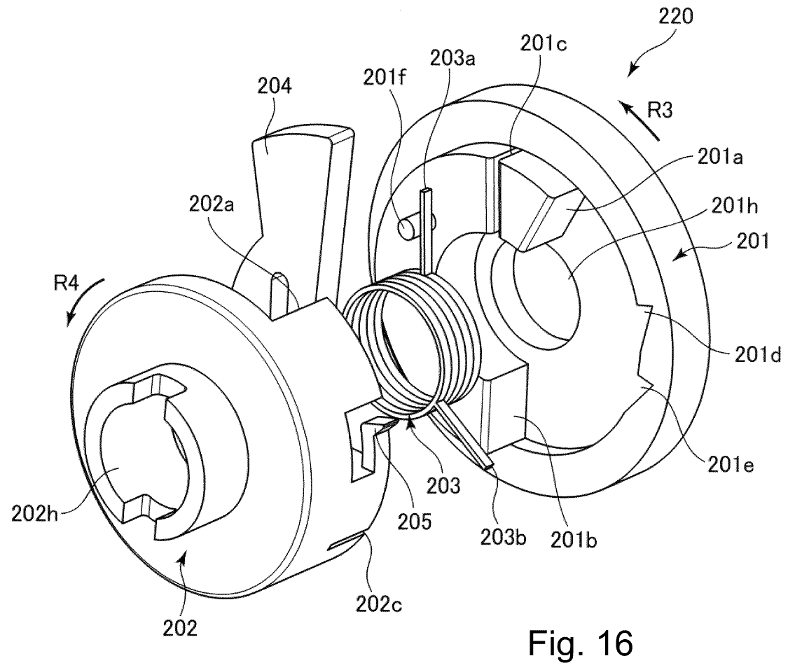

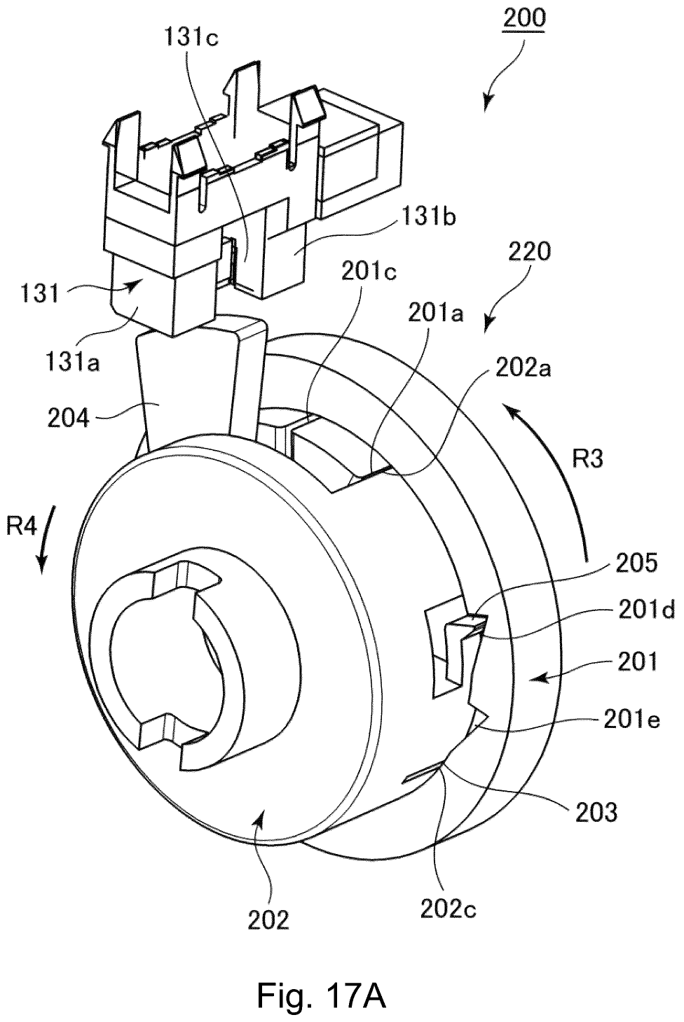

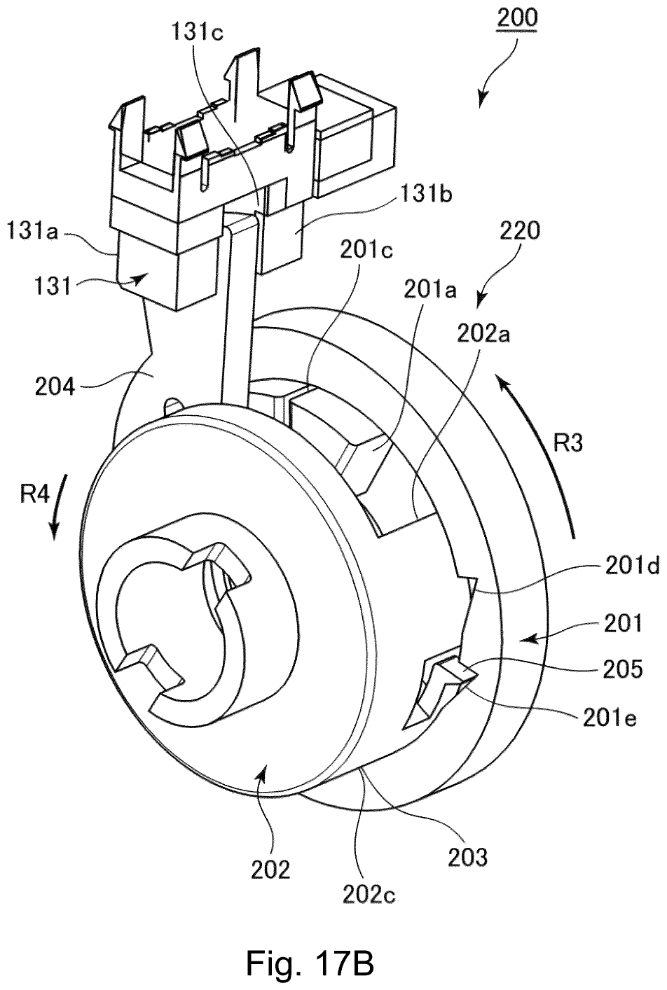

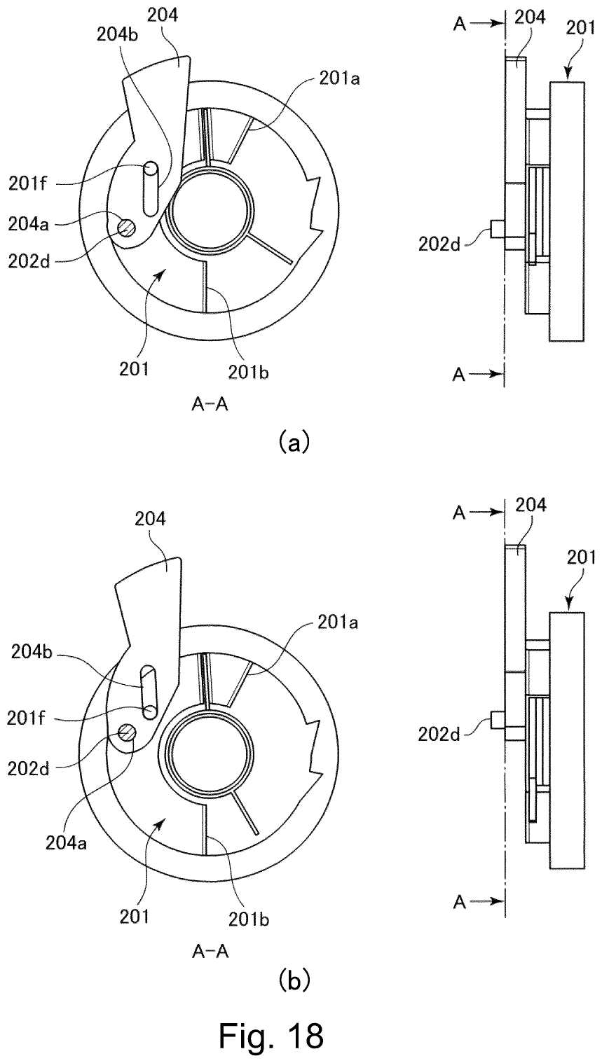

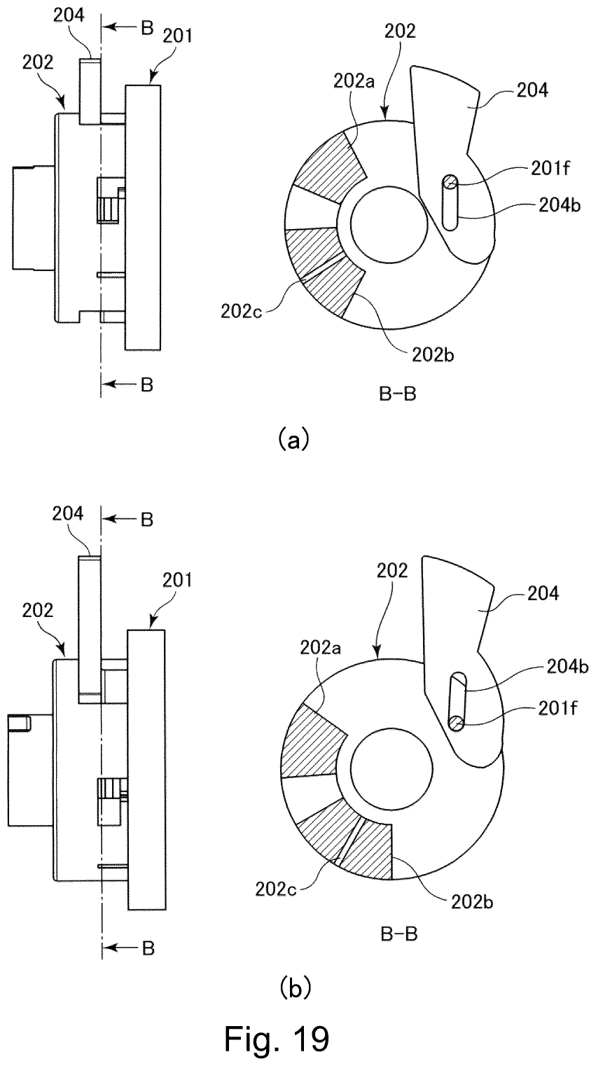

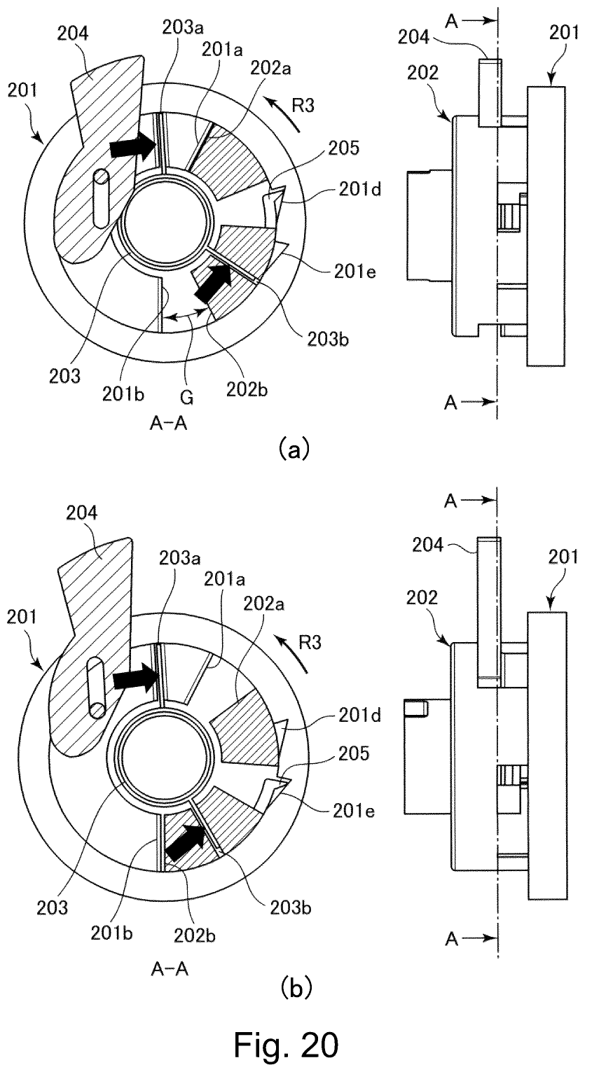

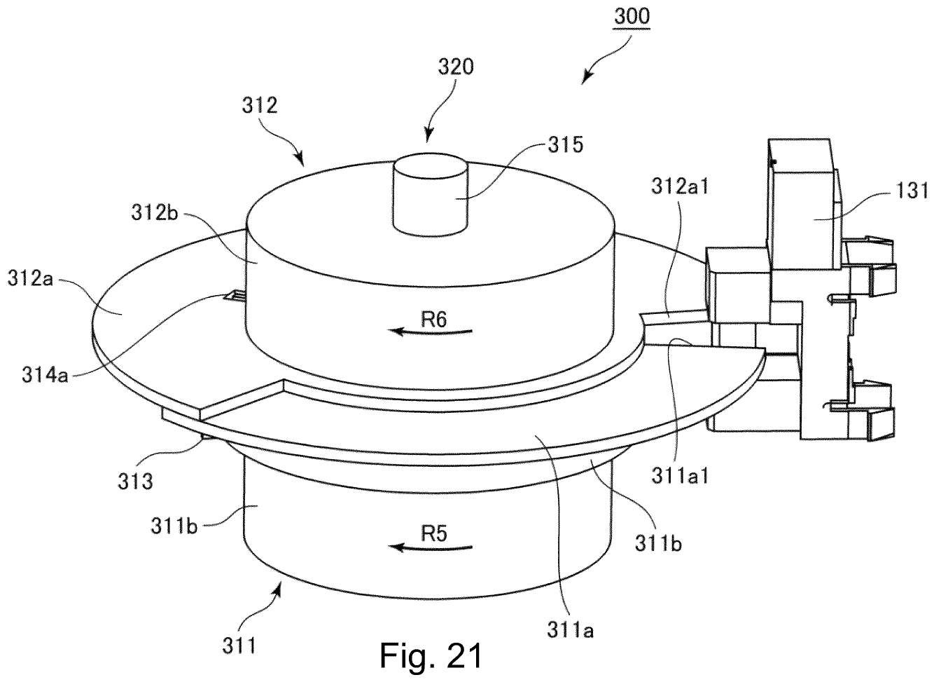

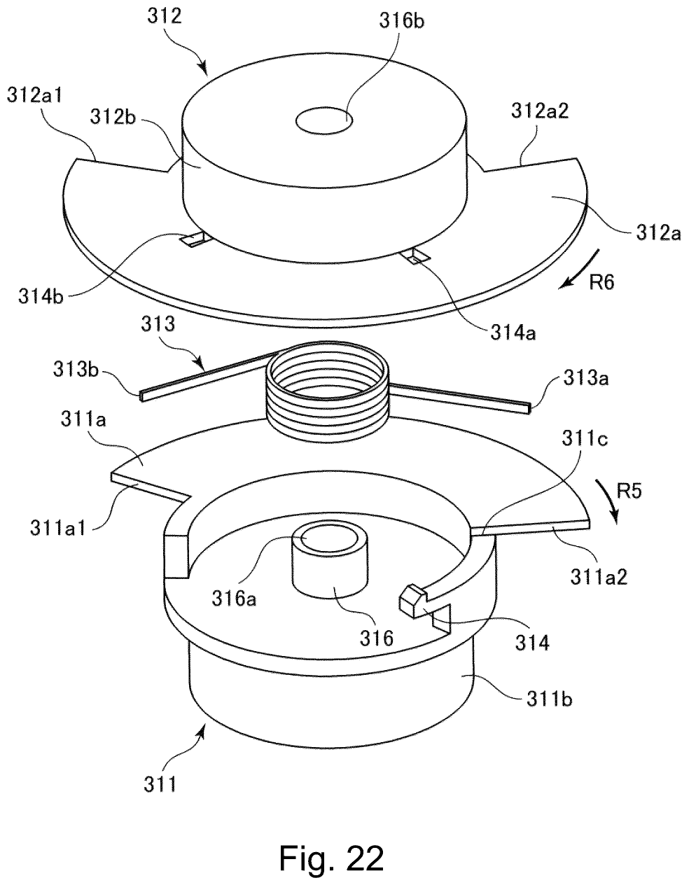

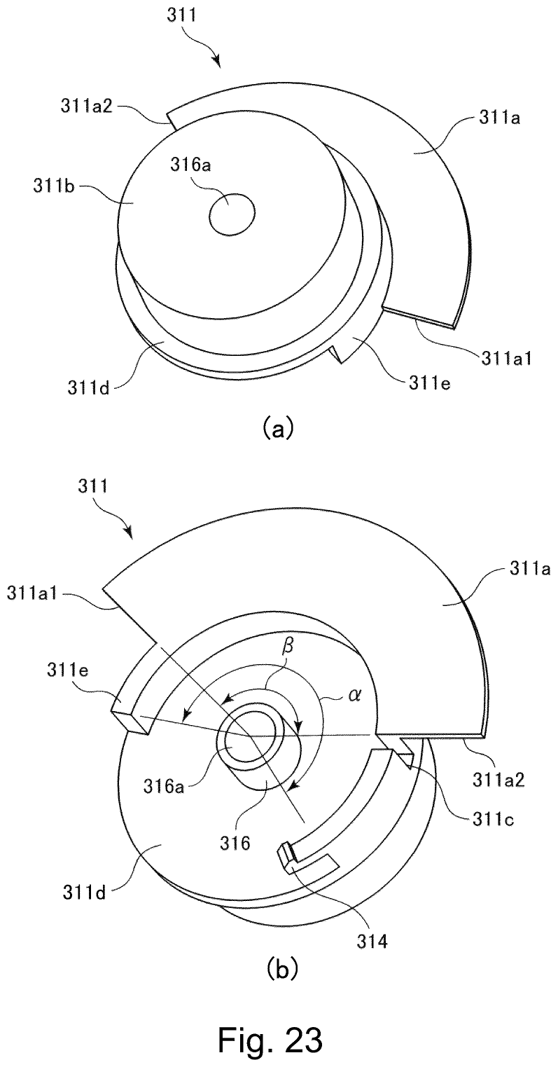

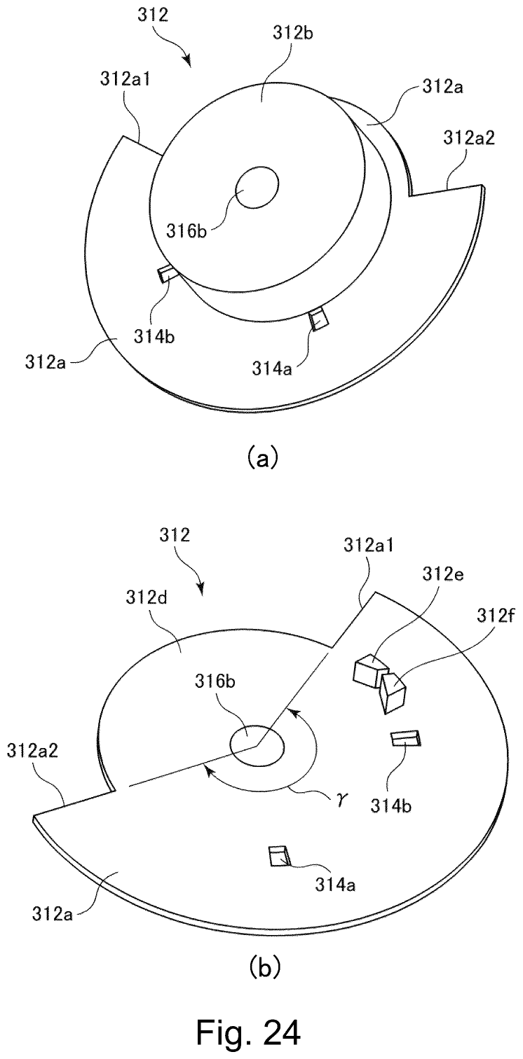

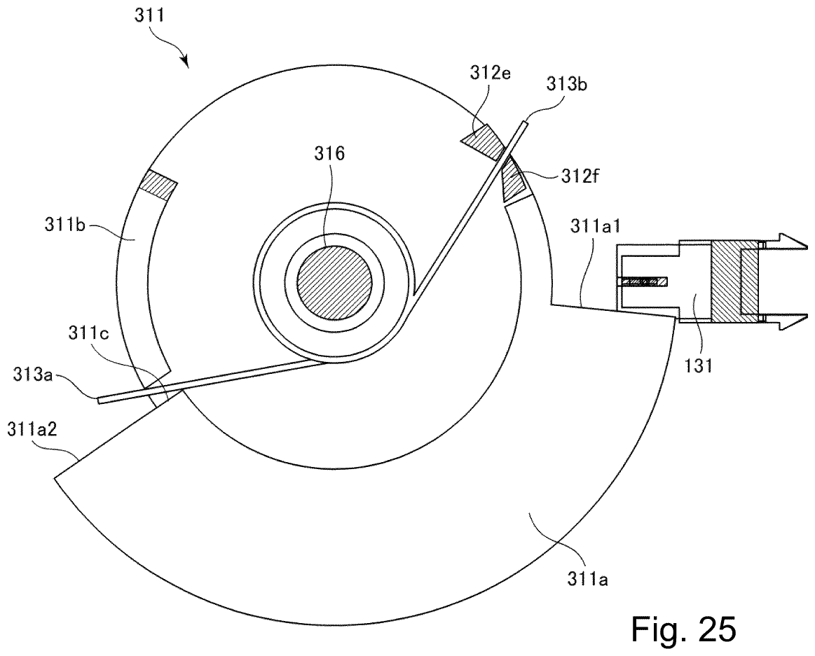

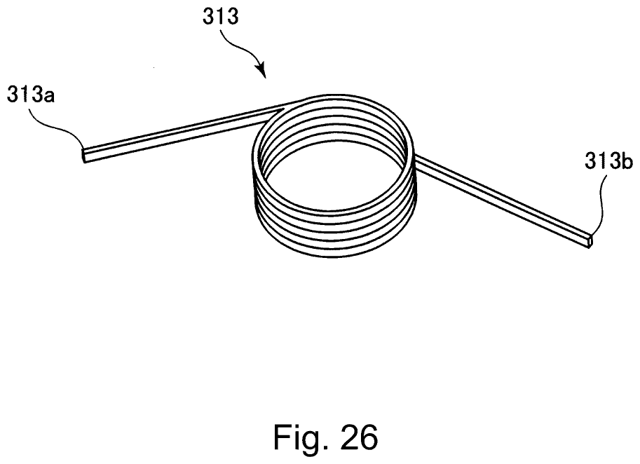

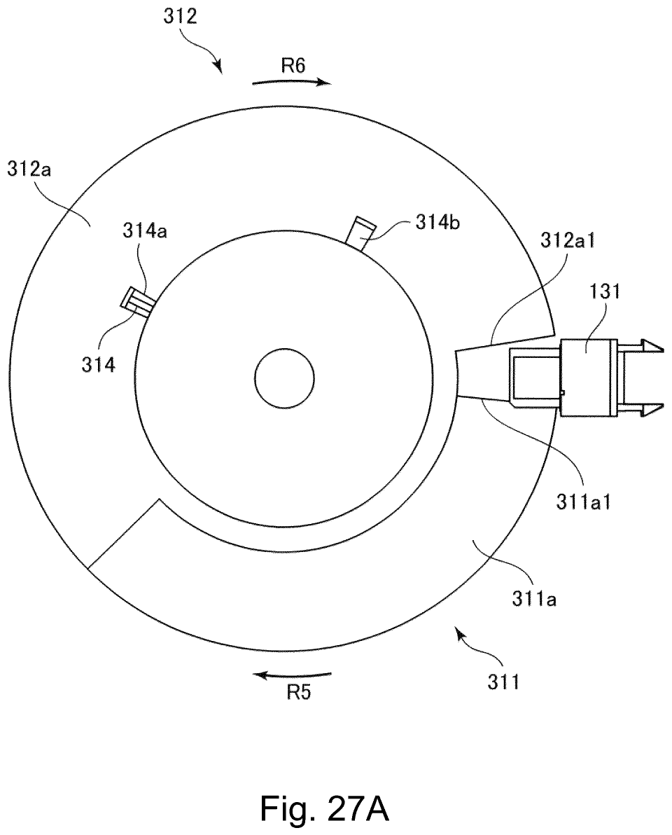

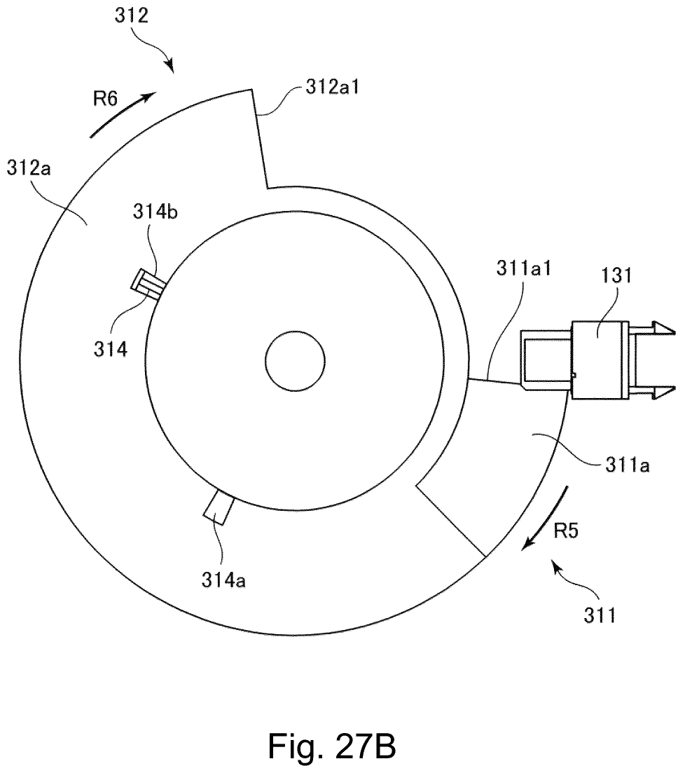

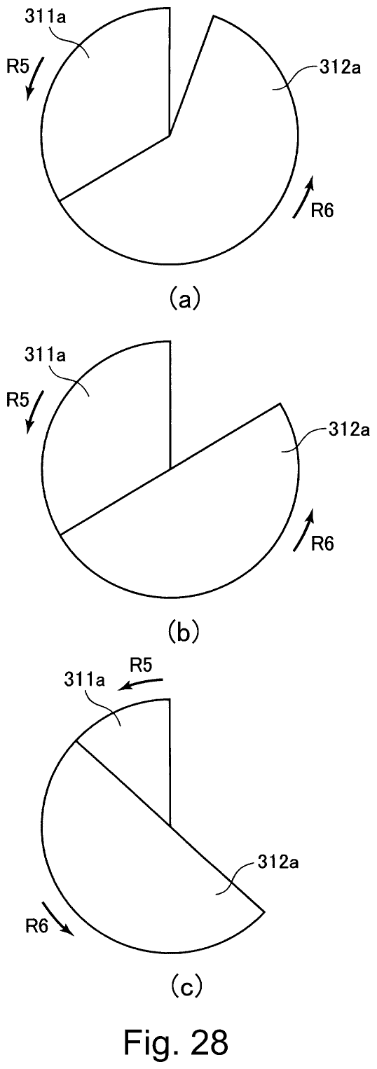

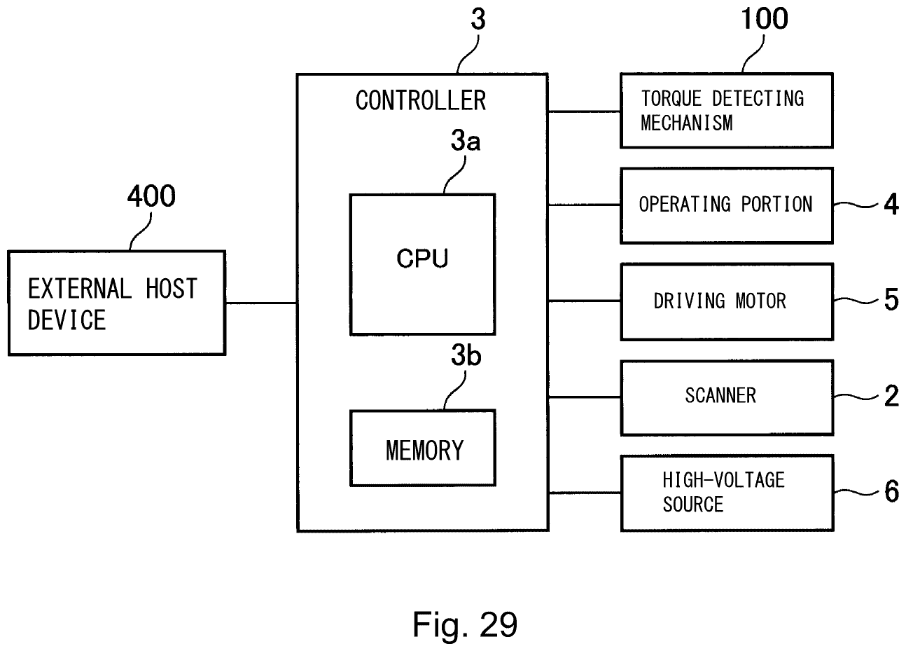

By using FIGS. 8 to 10, the drive connection mechanism 120 as a drive connecting means (drive connection portion) for transmitting the driving force from the driving motor 5 to the waste toner conveying screw 113 in this embodiment will be described. FIG. 9 is a perspective view of the drive connection mechanism 120 in this embodiment. FIG. 10 is an exploded perspective view of the drive connection mechanism 120 in this embodiment.

As shown in FIG. 8, the waste toner conveying screw 113 and the driving roller 46 are drive-connected to each other by the drive connection mechanism 120 provided to the transfer unit 40. The drive connection mechanism 120 is provided in an end portion of the driving roller 46 on a left side with respect to the rotational axis direction of the driving roller 46. As shown in FIGS. 9 and 10, the drive connection mechanism 120 is constituted by including a movable gear 121, a fixed gear 122, a detecting lever 123, an urging spring 124, a cover member 125, a driving gear 126, and an idler gear 127.

The movable gear 121 is a drive transmitting member for receiving the driving force from a driving roller 46 side and is provided movably along a rotation axis direction thereof. The movable gear 121 is movable to a first position and a second position which are changed in relative position to the fixed gear 122 with respect to the rotation axis direction in interrelation with a change in relative position of the fixed gear 122 to the movable gear 121 with respect to a rotational direction depending on a magnitude of the rotational load torque of the waste toner conveying screw 113 as described later. The fixed gear 122 is a drive transmitting member for receiving the driving force from the movable gear 121 by being engaged with the movable gear 121 and for transmitting the driving force to the waste toner conveying screw 113 by being engaged with a waste toner conveying screw gear 113a provided to the waste toner conveying screw 113. The waste toner conveying screw gear 113a is provided to the rotation shaft of the waste toner conveying screw 113 so as to be rotated integrally with the waste toner conveying screw 113 in one end portion (end portion on the left side and on the front side) of the waste toner conveying screw 113 with respect to the rotational axis direction. The detecting lever 123 is a detecting member for detecting movement of the movable gear 121 by being moved integrally with the movable gear 121. The detecting lever 123 includes a lever portion 123a and a lever supporting portion 123b, and the lever supporting portion 123b is engaged in a movable gear recessed portion 121f provided in the movable gear 121. By this, the detecting lever 123 is held by the movable gear 121 rotatably relative to the movable gear 121 so that a position of the lever portion 123a with respect to the rotation direction of the movable gear 121 is maintained. The urging spring 124 is an urging member (a compression coil spring which is an elastic member in this embodiment) as an urging means for urging the movable gear 121 through the detecting lever 123 toward the fixed gear 122 along the rotational axis direction of the movable gear 121. The cover member 125 is a holding member having a function of holding the drive connection mechanism 120 to the transfer frame 48, and is fixed to the transfer frame 48. The driving gear 126 is provided to a rotation shaft 46a of the driving roller 46 so as to be rotated integrally with the driving roller 46 in one end portion (end portion on the left side) of the driving roller 46 with respect to the rotational axis direction. The idler gear 127 receives the driving force from the driving gear 126 by being engaged with the driving gear 126, and transmits the driving force to the movable gear 121. That is, the driving gear 126 transmits the drive to the movable gear 121 through the idler gear 127. From the driving motor 5 toward the driving roller 46, for example, the driving force is inputted through a drive connection portion (not shown) provided in the other end portion (end portion on the right side) with respect to the rotational axis direction of the driving roller 46.

Here, a surface of the fixed gear 122 on a side opposite from the movable gear 121 with respect to the rotational axis direction abuts against a wall surface of the transfer frame 48. The urging spring 124 is disposed between the cover member 125 of which position is fixed and the detecting lever 123 movable together with the movable gear 121 along the rotational axis direction of the movable gear 121. Further, the movable gear 121 and the detecting lever 123 are urged by the urging spring 124 toward the fixed gear 122 along the rotational axis direction of the movable gear 121. That is, the movable gear 121 and the detecting lever 123 are disposed between the fixed gear 122 and the cover member 125 with a degree of freedom such that the movable gear 121 and the detecting lever 123 are movable along the rotational axis direction of the movable gear 121.

Thus, the drive connection mechanism 120 includes the movable gear 121 as a first rotatable member (first member, rotatable member) disposed on an input side of the rotational driving force, the fixed gear 122 as a second rotatable member (second member, member-to-be-rotated) provided coaxially with and rotatably relative to the first rotatable member and disposed on an output side of the rotational driving force, the urging spring 124 as the urging member (elastic member) for applying an urging force (elastic force) in a direction in which the movable gear 121 and the fixed gear 122 are urged against each other along the rotational axis direction, and the detecting lever 123 movable together with the movable gear 121.

Parts (a) and (b), and (c) and (d) of FIG. 11 are perspective views and front views, respectively, specifically showing the movable gear 121 and the fixed gear 122, respectively, in this embodiment. Part (a) of FIG. 11 is the perspective view showing a surface of the movable gear 121 on the fixed gear 122 side in the rotational axis direction of the movable gear 121, and part (b) of FIG. 11 is the front view showing the surface of the movable gear 121. Part (c) of FIG. 11 is the perspective view showing a surface of the fixed gear 122 on the movable gear 121 side in the rotational axis direction of the fixed gear 122, and part (d) of FIG. 11 is the front view showing the surface of the fixed gear 122.

The movable gear 121 and the fixed gear 122 include cam shapes (cam shape portions) engageable with each other.

The movable gear 121 rotates in an arrow R1 direction in parts (a) and (b) of FIG. 11. The movable gear 121 includes the cam shape along the rotational direction (circumferential direction on a surface thereof on the fixed gear 122 side with respect to the rotational axis direction). The movable gear 121 includes a first inclined surface portion 121a, a flat surface portion 121b, a first vertical wall portion 121c, a second vertical wall portion 121d, and a second inclined surface portion 121e. Of the first inclined surface portion 121a and the second inclined surface portion 121e, the first inclined surface portion 121a is provided on a downstream side of the movable gear 121 with respect to the rotational direction, and the second inclined surface portion 121e is provided on an upstream side of the movable gear 121 with respect to the rotational direction. The first inclined surface portion 121a is inclined with respect to the rotational axis direction of the movable gear 121 so as to approach the fixed gear 122 toward the upstream side of the movable gear 121 with respect to the rotational direction. Further, the second inclined surface portion 121e is inclined with respect to the rotational axis direction of the movable gear 121 so as to be separated from the fixed gear 122 toward the upstream side of the movable gear 121 with respect to the rotational direction. Further, on a surface of a base portion 121g, on the fixed gear 122 side, where the first inclined surface portion 121a and the second inclined surface portion 121e, a projected shape portion including the first vertical wall portion 121c, the second vertical wall portion 121d, and the flat surface portion 121b are provided. Each of the first vertical wall portion 121c and the second vertical wall portion 121d extends along (in this embodiment, substantially parallel to) the rotational axis direction of the movable gear 121. Of the first vertical wall portion 121c and the second vertical wall portion 121d, the first vertical wall portion 121c is provided on the downstream side of the movable gear 121 with respect to the rotational direction, and the second vertical wall portion 121d is provided on the upstream side of the movable gear 121 with respect to the rotational direction. The flat surface portion 121b extends between the first vertical wall portion 121c and the second vertical wall portion 121d along a surface of the movable gear 121 crossing (in this embodiment, substantially perpendicular to) the rotational axis direction of the movable gear 121. Further, the movable gear 121 includes a gear portion 121i at an outer periphery thereof.

The fixed gear 122 rotates in an arrow R2 direction in parts (c) and (d) of FIG. 11. The fixed gear 122 includes the cam shape along the rotational direction (circumferential direction) on a surface thereof on the movable gear 121 side with respect to the rotational axis direction. The fixed gear 122 includes a first fixing inclined surface portion 122a, a first fixing flat surface portion 122b, a first fixing vertical wall portion 122c, a second fixing vertical wall portion 122d, a second fixing inclined surface portion 122e, and a second fixing flat surface portion 122f. Of the first fixing inclined surface portion 122a and the second fixing inclined surface portion 122e, the first fixing inclined surface portion 122a is provided on an upstream side of the fixed gear 122 with respect to the rotational direction, and the second fixing inclined surface portion 122e is provided on a downstream side of the fixed gear 122 with respect to the rotational direction. The first fixing inclined surface potion 122a is inclined with respect to the rotational axis direction of the fixed gear 122 so as to be separated from the movable gear 121 toward the upstream side of the fixed gear 122 with respect to the rotational direction. Further, the second fixing inclined surface portion 122e is inclined with respect to the rotational axis direction of the fixed gear 122 so as to approach the movable gear 121 toward the upstream side of the fixed gear 122 with respect to the rotational direction. Further, on a surface of a fixing base portion 122g, on the movable gear 121 side, where the first fixing inclined surface portion 122a and the second fixing inclined surface portion 122e are formed, a fixing projected shape portion 122h including the first fixing vertical wall portion 122c and the second fixing vertical wall portion 122d is provided. Each of the first fixing vertical wall portion 122c and the second fixing vertical wall portion 122d extends along (in this embodiment, substantially parallel to) the rotational axis direction of the fixed gear 122. Of the first fixing vertical wall portion 122c and the second fixing vertical wall portion 122d, the first fixing vertical wall portion 122c is provided on the upstream side of the fixed gear 122 with respect to the rotational direction, and the second fixing vertical wall portion 122d is provided on the downstream side of the fixed gear 122 with respect to the rotational direction. Each of the first fixing flat surface portion 122b and the second fixing flat surface portion 122f extends along a surface of the fixed gear 122 crossing (in this embodiment substantially perpendicular to) the rotational axis direction of the fixed gear 122. Of the first fixing flat surface portion 122b and the second fixing flat surface portion 122f, the first fixing flat surface portion 122b is provided on the upstream side of the fixed gear 122 with respect to the rotational direction, and the second fixing flat surface portion 122f is provided on the downstream side of the fixed gear 122 with respect to the rotational direction. The first fixing flat surface portion 122b and the second fixing flat surface portion 122f are provided on the upstream side and the downstream side, respectively, with respect to the rotational direction of the fixed gear 122, while sandwiching the fixing projected shape portion 122h therebetween. Further, the fixed gear 122 includes a gear portion 122i at an outer periphery thereof.

Incidentally, in this embodiment, the movable gear 121 is provided with a cam shape (portion) which is the same as the above-described cam shape also on an opposite side (in a position shifted by 180 degrees with respect to the rotation direction) with respect to the rotational axis direction of the movable gear 121. Similarly, the fixed gear 122 is provided with a cam shape (portion) which is the same as the above-described can shape also on an opposite side (in a position shifted by 180 degrees with respect to the rotational direction) with respect to the rotational axis direction of the fixed gear 122.

Parts (a), (b), and (c) of FIG. 12 are sectional views in which the cam shapes of the movable gear 121 and the fixed gear 122 are cut at broken line portions in parts (b) and (d) of FIG. 11, and each schematically shows an operation of the drive connection mechanism 120 during a rotational operation of the driving roller 46. Each of parts (a), (b), and (c) of FIG. 12 shows a state of the movable gear 121 and the fixed gear 122 in the case where an amount of the waste toner in the waste toner collecting container 10 (a rotational load torque of the waste toner conveying screw 113) is different as described later.

The movable gear 121 is urged by the urging spring 124 with a spring force (spring pressure) Fs toward the fixed gear 122 along the rotational axis direction of the movable gear 121. When the movable gear 121 is rotated in the arrow R direction by receiving drive input, the first inclined surface portion (first contact portion) 121a and the first fixing inclined surface portion (third contact portion) 122a are in contact with each other, so that the movable gear 121 receives a reaction force Ft depending on a rotational load torque of the fixed gear 122. Part (a) of FIG. 12 shows a state in which the amount of the waste toner in the waste toner collecting container 10 is less than a predetermined amount (herein, this state also referred to as a “normal state”). In this state, the amount of the waste toner in the waste toner collecting container 10 is less than the predetermined amount, and therefore, the rotational load torque of the fixed gear 122 receiving a conveyance resistance of the waste toner is smaller than a predetermined value. That is, the reaction force Ft exerted on the movable gear 121 is smaller than the spring force Fs, and therefore, the first inclined surface portion 121a and the first fixing inclined surface portion 122a contact (engage with) each other, so that the driving force is transmitted from the movable gear 121 to the fixed gear 122. Further, the fixed gear 122 is rotated in the arrow R2 direction.

When the amount of the waste toner in the waste toner collecting container 10 reaches the predetermined amount (near full state in this embodiment), the rotational load torque of the fixed gear 122 increases, so that the reaction force Ft exerted on the movable gear 121 balances with the spring force Fs. Then, with an increase in amount of the waste toner in the waste toner collecting container 10, as shown in part (b) of FIG. 12, the first inclined surface portion 121a and the first fixing inclined surface portion 122a relative slide with each other. By this, the movable gear 121 moves in a direction (direction in which the movable gear 121 is separated from the fixed gear 122 along the rotational axis direction of the movable gear 121) opposite to the urging direction of the urging spring 124.

Thereafter, as shown in part (c) of FIG. 12, the first inclined surface portion 121a and the first fixing inclined surface portion 122a are in separated state. Further, as shown in part (c) of FIG. 12, a state in which the flat surface portion 121b and the first fixing flat surface portion 122b contact (engage with) each other and in which the first vertical wall portion (second contact portion) 121c and the first fixing vertical wall portion (fourth contact portion) 122c contact (engage with) each other is formed. That is, when the amount of the waste toner in the waste toner collecting container 10 becomes the predetermined amount or more, the first vertical wall portion 121c and the first fixing vertical wall portion 122c contact each other, so that the driving force is transmitted from the movable gear 121 to the fixed gear 122.

As described above, in this embodiment, a rotationally driving direction of the driving roller 46 for driving the belt 41 is one direction, so that the movable gear 121 is not reversely rotated. For that reason, in the case where the movable gear 121 and the fixed gear 122 are in a state shown in part (c) of FIG. 12, the flat surface portion 121b and the first fixing flat surface portion 122b contact each other, so that the movable gear 121 is held in a state in which the movable gear 121 cannot be moved in the rotational axis direction thereof. The flat surface portion 121b and the first fixing flat surface portion 122b function as a restricting portion as a restricting means for restricting that a phase which is a position of the movable gear 121 relative to the fixed gear 122 with respect to the rotational direction is returned from a second phase (state in which the rotational load torque is the predetermined value or more) to a first phase (state in which the rotational load torque is less than the predetermined value). As described above, when the state of the waste toner in the waste toner collecting container 10 is changed due to a factor such as vibration or the like by an operation or the like of the user and thus the conveyance resistance of the waste toner conveying screw 113 lowers, the rotational load torque of the fixed gear 122 lowers in some instances. In this embodiment, when the movable gear 121 and the fixed gear 122 are once in the state shown in part (c) of FIG. 12, thereafter even when the rotational load torque of the fixed gear 122 lowers, the movable gear 121 and the fixed gear 122 maintain the state shown in part (c) of FIG. 12. That is, the movable gear 121 and the fixed gear 122 maintain a state in which the first inclined surface portion 121a and the first fixing inclined surface portion 122a are separated from each other.

That is, even when the state of the waste toner in the waste toner collecting container 10 changes and the conveyance resistance of the waste toner conveying screw 113 lowers, the movable gear 121 and the fixed gear 122 do not return to the state shown in part (a) of FIG. 12 in which the first inclined surface portion 121a and the first fixing inclined surface portion 122a contact each other and thus the driving force is transmitted.

Thus, in this embodiment, even when the amount of the waste toner in the waste toner collecting container 10 increases and the conveyance resistance of the waste toner conveying screw 113 increases, drive transmission between the movable gear 121 and the fixed gear 122 is continuously performed while changing a driving force transmitting portion. For that reason, even after the near full state is detected, it becomes possible to continuously convey the waste toner to the waste toner collecting container 10. For that reason, before and after the near full state is detected, it becomes possible to continuously collect the waste toner in the same space (region), i.e., the waste toner collecting container 10 in this embodiment.

That is, there is no need to ensure another space for permitting collection of the waste toner conveyed after the near full state is detected. Further, there is also no need to accommodate the waste toner in the waste toner conveying phase after the near full state is detected. Accordingly, downsizing and cost reduction of the printer 1 can be realized.

Incidentally, in this embodiment, both the first inclined surface portion 121a and the first fixing inclined surface portion 122a are made the surfaces inclined with respect to the rotational axis direction of the movable gear 121, but at least one of these portions may only be required to be made such an inclined surface. For example, one portion is made the surface inclined with respect to the rotational axis direction of the movable gear 121, and the other portion may be made a rib shape (portion) or a boss shape (portion) which contacts the inclined surface. Further, in this embodiment, both the first vertical wall portion 121c and the first fixing vertical wall portion 122c which contact each other are made surfaces substantially parallel to the rotational axis direction of the movable gear 121, but at least one of these portions may only be required to be made such a surface. For example, one portion is made the surface substantially parallel to the rotational axis direction of the movable gear 121, and the other portion may be made a rib shape or a boss shape which contacts the surface. Further, in this embodiment, the flat surface portion 121b as the restricting portion provided on the movable gear 121 restricted the change in phase of the fixed gear 122 in contact with the first fixing flat surface portion 122b of the fixed gear 122. However, as is understood from part (c) of FIG. 12, the restricting portion (flat surface portion of a top portion of the fixing projected shape portion 122h) provided to the fixed gear 122 contacts the movable gear 121, so that the restricting portion may restrict the change in phase of the fixed gear 122. That is, the restricting portion may only be required to be provided to at least one of the movable gear 121 and the fixed gear 122.

Parts (a) and (b) of FIG. 13 are perspective views each showing the torque detecting mechanism 100 as a torque detecting means for detecting that the rotational load torque of the waste toner conveying screw 113 in this embodiment because a predetermined value or more (overload state). Further, parts (a) and (b) of FIG. 14 are sectional views each showing the torque detecting mechanism 100 in this embodiment.

As shown in parts (a) and (b) of FIG. 13 and parts (a) and (b) of FIG. 14, a detecting flag 130 and a detecting sensor 131 are mounted to and held by a sensor holder 132 provided to a main assembly side plate 1g which is a side plate provided to the apparatus main assembly 1a. The detecting flag 130 includes a flag rotation shaft 130a, a movement receiving portion 130b contactable to a lever portion 123a of a detecting lever 123 provided to the drive connection mechanism 120, and a light blocking portion 130c capable of entering into and retracting from a detecting region 131c of the detecting sensor 131. The detecting flag 130 is mounted to a sensor holder 132 so as to be rotatable about the flag rotation shaft 130a by that the flag rotation shaft 130a is rotatably supported by the sensor holder 132. further, an attitude of the detecting flag 130 is held so that the movement receiving portion 130b is moved toward the detecting lever 123 side by a spring and a stopper which are not shown and so that the light blocking portion 130c is in a position retracted from the detecting region 131c of the detecting sensor 131 (at least an optical axis of detection light). That is, the attitude of the detecting flag 130 is held in a state of part (a) of FIG. 14. In this embodiment, the detecting sensor 131 constituting the detecting means is constituted by a light blocking/light transmission detecting sensor (photosensor). The detecting sensor 131 is constituted in a U-shape in cross section and includes a light projecting portion 131a, a light receiving portion 131b, and the detecting region 131c formed between the light projecting portion 131a and the light receiving portion 131b. The detecting region 131c constitutes an optical path of detection light from the light projecting portion 131a toward the light receiving portion 131b and permits positioning of the light blocking portion 130c of the detection flag 130 therein. In this embodiment, the torque detecting mechanism 100 is constituted by including the drive connection mechanism 120 when includes the movable gear 121, the fixed gear 122, the detecting lever 123, the urging spring 124, and the cover member 125, and by including the detecting flag 130 and the detecting sensor 131. In this embodiment, the torque detecting mechanism 100 is capable of detecting that the phase which is the position of the movable gear 121 relative to the fixed gear 122 with respect to the rotational direction is the first phase (state in which the rotational load torque is less than the predetermined value) and is the second phase (state in which the rotational load torque is the predetermined value or more) by detecting states of light blocking and light transmission by the detecting sensor 131.

Part (a) of FIG. 13 and part (a) of FIG. 14 show the state in which the amount of the waste toner in the waste toner collecting container 10 is less than the predetermined amount. That is, part (a) of FIG. 13 and part (a) of FIG. 14 show the normal state in which the movable gear 121 and the fixed gear 122 engage with each other by the first inclined surface portion 121a and the first fixing inclined surface portion 122a. Part (b) of FIG. 13 and part (b) of FIG. 14 show a state in which the amount of the waste toner in the waste toner collecting container 10 reached the predetermined amount, i.e., the near full state. That is, part (b) of FIG. 13 and part (b) of FIG. 14 show a state in which the movable gear 121 and the fixed gear 122 contact each other by the flat surface portion 121b and the first fixing flat surface portion 122b and by the first vertical wall portion 121c and the first fixing vertical wall portion 122c.

In the state, shown in part (a) of FIG. 13 and part (a) of FIG. 14, in which the amount of the waste toner in the waste toner collecting container 10 is less than the predetermined amount, the detecting lever 123 is separated from the movement receiving portion 130b of the detecting flag 130. Further, the light blocking portion 130c of the detecting flag 130 retracts from the detecting region 131c of the detecting sensor 131. As shown in part (b) of FIG. 13 and part (b) of FIG. 14, when the amount of the waste toner in the waste toner collecting container 10 reaches the predetermined amount, by the above-described operation, the movable gear 121 and the detecting lever 123 are moved along the rotational axis direction of the movable gear 121. When the lever portion 123a of the detecting lever 123 contacts the movement receiving portion 130b of the detecting flag 130 with this movement, the detecting flag 130 is rotated about the flag rotation shaft 130a. By this, the light blocking portion 130c of the detecting flag 130 enters the detecting region 131c of the detecting sensor 131 and blocks the optical axis of the detection light of the detecting sensor 131. Thus, the detecting sensor 131 detects the light blocking state, whereby the torque detecting mechanism 100 can detect that the inside of the waste toner collecting container 10 is in the near full state. That is, the state of the detecting sensor 131 is capable of shifting to the light transmission state as a first state and the light blocking state as a second state. The detecting flag 130 shifts the state of the detecting sensor 131 to the light blocking state or the light transmission state. The detecting flag 130 puts the state of the detecting sensor 131 in the light blocking state by blocking the optical path of the detecting sensor 131, and puts the state of the detecting sensor 131 in the light transmission state by opening the optical path of the detecting sensor 131. The detecting sensor 131 outputs different detection signals depending on the light blocking state and the light transmission state, respectively. For example, an output signal of the detecting sensor is turned off (OFF) in the light transmission state and is turned on (ON) in the light blocking state. This signal is inputted to the controller 3. By this, the controller 3 is capable of discriminating (detecting) that the state of the inside of the waste toner collecting container 10 is the near full state. Incidentally, the detecting sensor 131 may only be required to be capable of detecting at least one of light blocking and light transmission of the detection light.

As described above, the state of the waste toner in the waste toner collecting container 10 is not necessarily stabilized, and by applying a shock to the waste toner collecting container 10 through an operation thereof by the user or the like, the rotational load torque of the waste toner conveying screw 113 is decreased in some instances. On the other hand, in this embodiment, the torque detecting mechanism 100 (drive connection mechanism 120) becomes the following state when the rotational load torque of the waste toner conveying screw 113 becomes the predetermined value (overload state), i.e., the near full state. That is, as shown in part (c) of FIG. 12, the torque detecting mechanism 100 becomes a state in which the movable gear 121 and the fixed gear 122 contact each other by the flat surface portion 121b and the first fixing flat surface portion 122b. For that reason, even when the rotational load torque of the waste toner conveying screw 113 is decreased as described above after the torque detecting mechanism 100 detects the near full state, the torque detecting mechanism 100 maintains the state shown in part (c) of FIG. 12 and does not return to the normal state shown in part (a) of FIG. 12. That is, even when the rotational load torque of the waste toner conveying screw 113 is lowered by a change in state of the waste toner in the waste toner collecting container 10 due to a factor such as vibration or the like after the detection of the near full state, the torque detecting mechanism 100 is capable of maintaining a state in which the torque detecting mechanism 100 detected the near full state.

Thus, the image forming apparatus (printer) 1 includes the driven member (waste toner conveying screw) 113; the driving source (driving motor 5) for generating a driving force for rotationally driving the driven member 113; the first rotatable member (movable gear) 121 for being rotated by input of the driving force from the driving source 5 thereto; the second rotatable member (fixed gear) 122 provided coaxially with the first rotatable member 121 and for transmitting the driving force toward the driven member 113 by being rotated through transmission thereto the driving force from the driving source 5 by the first rotatable member 121, the second rotatable member 122 being rotatable relative to the first rotatable member 121 so that a phase which is a position of the second rotatable member 122 relative to the first rotatable member 121 with respect to a rotational direction of the first rotatable member 121 changes from a first phase toward a second phase; the detecting means (detecting flag 130, detecting sensor 131) capable of detecting that the second rotatable member is in the second phase; and the restricting means (flat surface portion 121b, first fixing flat surface portion 122b) for restricting the phase. Further, in this embodiment, the first rotatable member 121 and the second rotatable member 122 are configured to as to change the phase with a change in rotational load torque of the driven member 113 from a first torque to a second torque larger than the first torque so that the first rotatable member 121 and the second rotatable member 122 are rotated in a state in which the second rotatable member 122 is in the first phase in a case where the rotational load torque of the driven member is the first torque and so that the first rotatable member 121 and the second rotatable member 122 are rotated in a state in which the second rotatable member 122 is in the second phase in a case where the rotational load torque of the driven member 113 is the second torque. Further, in this embodiment, in the case where the phase changes from the first phase to the second phase, even when the rotational load torque of the driven member 113 lowers from the second torque toward the first torque, the restricting means restricts that the phase returns from the second phase to the first phase.

In this embodiment, the first rotatable member 121 includes the first contact portion (first inclined surface portion) 121a for transmitting the driving force to the second rotatable member 122 in contact with the second rotatable member 122 in the case where the second rotatable member 122 is in the first phase, and the second contact portion (first vertical wall portion) 121c for transmitting the driving force to the second rotatable member 122 in contact with the second rotatable member 122 in the case where the second rotatable member 122 is in the second phase, and the second rotatable member 122 includes the third contact portion (first fixing inclined surface portion) 122a for receiving the driving force from the first rotatable member 121 in contact with the first contact portion 121a in a case where the second rotatable member 122 is in the first phase, and the fourth contact portion (first fixing vertical wall portion) 122c for receiving the driving force from the first rotatable member 121 in contact with the second contact portion 121c in the case where the second rotatable member 122 is in the second phase. When the rotational load torque of the driven member 113 changes from the first torque to the second torque, a position of the first rotatable member 121 relative to the second rotatable member 122 in a rotational axis direction of the first rotatable member 121 is changed by a change in position of the first contact portion 121a relative to the third contact portion 122a in the rotational axis direction of the first rotatable member 121. Here, at least one of the first contact portion 121a and the third contact portion 122a can be configured to include a surface inclined with respect to the rotational axis direction of the first rotatable member 121. Further, at least one of the second contact portion 121c and the fourth contact portion 122c can be configured to have a surface substantially parallel to the rotational axis direction of the first rotatable member 121. Further, in this embodiment, the above-described restricting means is constituted by including at least one of the restricting portion (flat surface portion) 121b provided to the first rotatable member 121 and for restricting charge in the position of the first rotatable member 121 relative to the second rotatable member 122 in the rotational axis direction of the first rotatable member 121 in contact with the second rotatable member 122 in the case where the second rotatable member 122 is in the second phase, and the restricting portion provided to the second rotatable member 122 and for restricting a change in the position of the first rotatable member 121 relative to the second rotatable member 122 in the rotational axis direction of the first rotatable member 121 in contact with the first rotatable member 121 in the case where the second rotatable member 122 is in the second phase.

Further, in this embodiment, the image forming apparatus 1 includes the urging member (urging spring) 124 configured to apply an urging force along the rotational axis direction of the first rotatable member 121 in a direction in which the first rotatable member 121 and the second rotatable member 122 are pressed against each other. Further, in this embodiment, the above-described detecting means is constituted by including the flag (detecting flag 130) changed in position in interrelation with the change in position of the above-described phase so as to be positioned in a first position (retracted position) in the case where the second rotatable member 122 is in the first phase and so as to be positioned in a second position (projected position) in the case where the second rotatable member 122 is in the second phase, and the sensor (detecting sensor 131) capable of detecting that the flag 130 is positioned in the second position. In this embodiment, the sensor 131 is constituted by including a photosensor for detecting at least one of blocking and transmission of detection light by a change in position of the flag 130.

Further, in this embodiment, the image forming apparatus 1 includes the image forming portion (cartridge) P configured to form a toner image; the endless belt 41 onto which the toner image formed by the image forming portion P is transferred; the cleaning portion 43 for removing toner from the belt 41; the waste toner collecting container 10 for accommodating the toner removed from the belt by the cleaning portion 43; and the waste toner conveying member 113 for conveying the toner in the waste toner collecting container 10. The driven member is the waste toner conveying member 113. Further, in this embodiment, the above-described second torque is a rotational load torque of the waste toner conveying member 113 in a case where an amount of the toner accommodated in the waste toner collecting container 10 reaches a predetermined amount. Further, in this embodiment, the unit (transfer unit) 40 including the belt 41, the cleaning portion 43, the waste toner collecting container 10, the waste toner conveying member 113, the first rotatable member 121, and the second rotatable member 122 is detachably mountable to a main assembly 1a of the image forming apparatus 1.

As described above, according to this embodiment, even in the case where the rotational load torque of the waste toner conveying screw 113 is below the predetermined value after the torque detecting mechanism 100 detected that the rotational load torque of the waste toner conveying screw 113 became the predetermined value or more, a detection result thereof is capable of being held.

### Embodiment 2

Next, another embodiment (embodiment 2) of the present disclosure will be described. In this embodiment, another example of the torque detecting mechanism for detecting that the rotational load torque of the waste toner conveying screw became the predetermined value or more (overload state) will be described. Basic constitution and operation of an image forming apparatus of this embodiment are the same as those of the image forming apparatus of the embodiment 1. Accordingly, as regards elements having functions or constitutions identical or corresponding to those of the elements of the image forming apparatus of the embodiment 1, detailed description thereof will be omitted by adding thereto the same reference numerals or symbols s those in the embodiment 1.

FIG. 15 is a perspective view of a drive connection mechanism 220 in this embodiment. Further, FIG. 16 is an exploded perspective view of the drive connection mechanism 220 in this embodiment.

As shown in FIGS. 15 and 16, the drive connection mechanism 220 includes a driving piece 201 as a first rotatable member (first member, rotatable member) provided on an input side of a rotational driving force, a driven piece 202 as a second rotatable (second member, member-to-be-driven) provided coaxially with an rotatably relative to the first rotatable member disposed on an output side of the rotational driving force, a torsion spring 203 as an driving member (elastic member) for applying an urging force (elastic force) along a rotational direction to between the driving piece 201 and the driven piece 202, and a detecting flag 204. The driving piece 201 transmits the driving force, inputted to the driving roller 46, to the driven piece 202. The driven piece 202 rotates the waste toner conveying screw 113 by transmitting the driving force, received from the driving piece 201, to the waste toner conveying screw 113. The driving piece 201 rotates in an arrow R3 direction in FIGS. 15 and 16. The driven piece 202 rotates in an arrow R4 direction in FIGS. 15 and 16. Incidentally, similarly as in the embodiment 1, in this embodiment, a rotational drive direction of the driving roller 46 for driving the belt 41 is one direction, so that the driving piece 201 is not reversely rotated. The driving piece 201 and the driven piece 202 are mounted rotatably about rotation shafts (not shown) through insertion holes 201h and 202h, respectively. Each of the driving piece 201 and the driven piece 202 may be constituted as a simple predetermined member, but may also be constituted as a gear for transmitting the rotational driving force by forming a tooth (gear portion) such as spur tooth at an out periphery thereof.

FIGS. 17A and 17B are perspective views of a torque detecting mechanism 200 in this embodiment. FIG. 17A shows a state in the case where a rotational load torque is smaller than a predetermined value, and FIG. 17B is a state in which the rotational load torque is the predetermined value or more. Left views of parts (a) and (b) of FIG. 18 are sectional views each showing a cross section (A-A cross section in an associated right view) substantially perpendicular to a rotational axis direction of the driving piece 201. Part (a) of FIG. 18 shows a state in the case where the rotational load torque is smaller than the predetermined value, and part (b) of FIG. 18 shows a state in the case where the rotational load torque is the predetermined value or more. Right views of parts (a) and (b) of FIG. 19 are sectional views each showing a cross section (B-B cross section in an associated left view) substantially perpendicular to a rotational axis direction of the driven piece 202. Part (a) of FIG. 19 shows a state in which the rotational load torque is smaller than the predetermined value, and part (b) of FIG. 19 shows a state in which the rotational load torque is the predetermined value or more. Left views of parts (a) and (b) of FIG. 20 are sectional views each showing a cross section (A-A cross section in an associated right view), substantially perpendicular to the rotational axis directions of the driving piece 201 and the driven piece 202, for illustrating a direction of a spring force of the torsion spring 203. Part (a) of FIG. 20 shows a state in which the rotational load torque is smaller than the predetermined value, and part (b) of FIG. 20 shows a state in which the rotational load torque is the predetermined value or more.

The driving piece 201 is constituted so as to transmit the rotational driving force to the driven piece 202 by engaging with the driven piece 202 with backlash in the rotational direction, i.e., a gap gear (part (a) of FIG. 20) in a predetermined amount (FIGS. 16 and 20). Further, one spring end portion 203a of the torsion spring 203 engages with a locking groove 201c provided to the driving piece 201, and the other spring end portion 203b of the torsion spring 203 engages with a locking groove 202c provided to the driven piece 202 (FIGS. 16 and 20). The torsion spring 203 is positioned between the driving piece 201 and the driven piece 202. Further, the driving piece 201 is provided with a first cut-away portion (engaging groove) 201d and a second cut-away portion (engaging groove) 201e for receiving an elastically deformable stopper 205 provided to the driven piece 202 (FIG. 16). The first cut-away portion 201d and the second cut-away portion 201e are provided along the rotational direction (circumferential direction) of the driving piece 201.

The torsion spring 203 urges the driving piece 201 and the driven piece 202 in the rotational direction with a predetermined spring force. Further, in a state in which there is no rotational load torque, a first contact surface 201a of the driving piece 201 and a first surface-to-be-contacted 202a of the driven piece 202 are in contact with each other (FIGS. 18 to 20). Further, in the state in which there is no rotational load torque, the stopper 205 is received by the first cut-away portion 201d (FIG. 17A and part (b) of FIG. 20). The spring force (spring pressure) of the torsion spring 203 is set to a predetermined rotational load torque when the waste toner in the waste toner collecting container 10 is conveyed by the waste toner conveying screw 113 in the case where the waste toner collecting container 10 is in the near full state. As described later, after the rotational load torque becomes the predetermined value or more, the stopper 205 is received by the second cut-away portion 201e, so that a position (phase) of the driven piece 202 relative to the driving piece 201 with respect to the rotational direction of the driving piece 201 (FIG. 17B).

As shown in parts (a) and (b) of FIG. 18 and parts (a) and (b) of FIG. 19, the detecting flag 204 is provided with a round hole-shaped first engaging portion 204a and an elongated hole-shaped second engaging portion 204b. In a state in which the second engaging portion 204b slidably engages with a boss 20f of the driving piece 201, the detecting flag 204 is disposed between the driving piece 201 and the driven piece 202 in rotatable engagement of the first engaging portion 204a with a boss 202d of the driven piece 202. The detecting flag 204 is capable of projecting in a direction, in which the detecting flag 204 is separated from rotational axis directions of the driving piece 201 and the driven piece 202, and capable of being retracted in a direction, in which the detecting flag 204 approaches the rotational axis directions, by a change in relative position between the driving piece 201 and the driven piece 202 with respect to the rotational direction. As shown in FIG. 17A and FIG. 17B, the printer 1 is provided with the detecting sensor 131 in proximity of the detecting flag 204. In this embodiment, the detecting sensor 131 as the detecting means is constituted by a light blocking/light transmission detecting sensor (photosensor) similar to that in the embodiment 1. The detecting sensor 131 is configured in a U-shape in cross section and includes the light projecting portion 131a, the light receiving portion 131b, and the detecting region 131c formed between the light projecting portion 131a and the light receiving portion 131b. When the detecting flag 204 projects from the driving piece 201 and the driven piece 202, the light blocking portion 204c of the detecting flag 204 is configured to enter into the detecting region 131c of the detecting sensor 131 and to block an optical axis of detection light. In this embodiment, the torque detecting mechanism 200 is constituted by including the driving piece 201, the driven piece 202, the drive connection mechanism 220 including the torsion spring 203 and the detecting flag 204, and the detecting sensor 131. In this embodiment, the torque detecting mechanism 200 is capable of detecting that the driven piece 202 is in the first phase and in the second phase, by detecting that the detecting sensor 131 detects a light blocking state and a light transmission state of the detection light.

In the constitution as described above, in the case where the driving force is inputted to the driving piece 201 and the rotational load torque of the waste toner conveying screw 113 is smaller than the predetermined value, the driven piece 202 is attracted to the driving piece 201 by the spring force of the torsion spring 203. Arrows in part (a) of FIG. 20 show directions of forces applied by the spring force of the torsion spring 203 at this time.

Further, in a state in which the first contact surface 201a of the driving piece 201 and the first surface-to-be-contacted 202a of the driven piece 202 are in contact with each other (in a state in which the gap G is formed), the driving piece 201 and the driven piece 202 are rotated. At this time, the detecting flag 204 engaged with each of the driving piece 201 and the driven piece 202 is rotated in a state (retracted position) in which the detecting flag 204 does not project from the driving piece 201 and the driven piece 202 (FIG. 17A, part (a) of FIG. 18, and part (a) of FIG. 19).

When the rotational load torque of the waste toner conveying screw 113 becomes the predetermined value, against the spring force of the torsion spring 203, the position (phase) of the driven piece 202 relative to the driving piece 201 with respect to the rotational direction of the driving piece 201 is changed toward an upstream side. Arrows in part (b) of FIG. 20 show directions of forces applied by the spring force of the torsion spring 203 at this time. Then, the gap G between the driving piece 201 and the driven piece 202 is eliminated, and a second contact surface 201b of the driving piece 201 and a second surface-to-be-contacted 202b of the driven piece 202 are in contact with each other, so that the driven piece 202 is rotated by the driving piece 201. At this time, by a change in relative position between the driving piece 201 and the driven piece 202, the detecting flag 204 is rotated in a state (projected position) in which the detecting flag 204 projects from the driving piece 201 and the driven piece 202 (FIG. 17B, part (b) of FIG. 18, part (b) of FIG. 19).

When the detecting flag 204 is rotated in a projected state (projected position), in rotation periods of the driving piece 201 and the driven piece 202, the detecting flag 204 blocks the optical axis of the detection light of the detecting sensor 131. This is detected by the detecting sensor 131, whereby it is possible to detect that the waste toner collecting container 10 becomes the near full state. Further, when the near full state is detected, the position (phase) of the driven piece 202 relative to the driving piece 201 with respect to the rotational direction of the driving piece 201 changes, so that the stopper 205 of the driven piece 202 is demounted from the first cut-away portion 201d of the driving piece 201. Then, the stopper 205 of the driven piece 202 is rotated while being bent inside a radial direction, and is received by the second cut-away portion 201e of the driving piece 201. Further, after the near full state is detected, the stopper 205 is maintained in a state in which the stopper 205 is received by the second cut-away portion 201e of the driving piece 201.

Thus, in this embodiment, the driven piece 202 engaging with the driving piece 201 with a predetermined gap G in a predetermined amount with respect to the rotational direction of the driving piece 201 is urged in a direction in which the gap gear is enlarged in the rotational direction by the torsion spring 203. When the rotational load torque of the waste toner conveying screw 113 becomes the predetermined value or more. The rotational load torque acting on the driven piece 202 becomes the predetermined value or more, so that the position (phase) of the driven piece 202 relative to the driving piece 201 with respect to the rotational direction of the driving piece 201 changes. That is, the gap G between the driving piece 201 and the driven piece 202 changes. By this, the detecting flag 204 is projected, so that the projected detecting flag 204 is detected by the detecting sensor 131. The stopper 205 of the driven piece 202 is moved from the first cut-away portion 201d to the second cut-away portion 201e of the driving piece 201 when the near full state is detected. The stopper 205 has a shape such that a shift in position (phase) of the driven piece 202 relative to the driving piece 201 with respect to the rotational direction of the driving piece 201 is restricted. For that reason, when the torque detecting mechanism 200 once changes to the state in which the near full state is detected, the stopper 205 is restricted from being demounted from the second cut-away portion 201e and moving to a position where the stopper 205 is received by the first cut-away portion 201d. As described above, when the state of the waste toner in the waste toner collecting container 10 is changed by the factor such as the vibration or the like and the conveyance resistance of the waste toner conveying screw 113 lowers, the rotational load torque of the waste toner conveying screw 113 lowers in some instances. In this embodiment, even in this case, the position (phase) of the driven piece 202 relative to the driving piece 201 with respect to the rotational direction of the driving piece 201 is not changed. For that reason, even when the rotational load torque of the waste toner conveying screw 113 is below the predetermined value, a state in which the detecting flag 204 is in the projected position is maintained, so that the detecting flag 204 is restricted from returning to the retracted position. That is, even when after the near full state is detected, the state of the waste toner in the waste toner collecting container 10 is changed by the factor such as the vibration or the like and the rotational load torque of the waste toner conveying screw 113 lowers, the torque detecting mechanism 200 is capable of maintaining the state in which the near full state is detected.

Incidentally, in this embodiment, the driven piece 202 is provided with the stopper 205 as the engaging portion for restricting the change in phase of the driven piece 202 by engagement with the driving piece 201. However, in place of or in addition to this engaging portion, the driving piece 201 may be provided with an engaging portion for restricting the change in phase of the driven piece 202 by engagement with the driven piece 202.

Thus, in this embodiment, the image forming apparatus 1 includes the urging member (torsion spring) 203 for engaging with the first rotatable member (driving piece) 201 and the second rotatable member (driven piece) 202 and for applying the urging force to between the first rotatable member and the second rotatable member along the rotational direction of the first rotatable member 201, and the urging member 203 is deformed so that with respect to the rotational direction of the first rotatable member 201, the second rotatable member 202 is positioned on an upstream side relative to the first rotatable member 201 in the case where the second rotatable member 202 is in the second phase (in the state in which the rotational load torque is the predetermined value or more) than in the case where the second rotatable member 202 is in the first phase (in the state in which the rotational load torque is less than the predetermined value). In this embodiment, the detecting means is constituted by including the flag (detecting flag) 204 changed in position in interrelation with a change in phase of the second rotatable member 202 relative to the first rotatable member 201 so that the flag 204 is in the first position in the case where the second rotatable member 202 is in the first phase and so that the flag 204 is in the second position in the case where the second rotatable member 202 is in the second phase, and by including the sensor (detecting sensor) 131 capable of detecting that the flag 204 is in the second position. In this embodiment, the sensor 131 is constituted by including the photosensor for detecting at least one of the light blocking and the light transmission of the detection light by the change in position of the flag 204. Further, in this embodiment, the restricting means is constituted by including at least one of an engaging portion which is provided to the first rotatable member 201 and which engages with the second rotatable member 202 in the case where the second rotatable member 202 is in the second phase, and the engaging portion (stopper) 205 which is provided to the second rotatable member 202 and which engages with the first rotatable member 201 in the case where the second rotatable member 202 is in the second phase.

As described above, also by the constitution of this embodiment, an effect similar to the effect of the constitution of the embodiment 1.

### Embodiment 3

Next, another embodiment (embodiment 3) of the present disclosure will be described. In this embodiment, another example of the torque detecting mechanism for detecting that the rotational load torque of the waste toner conveying screw became the predetermined value or more (overload state) will be described. Basic constitution and operation of an image forming apparatus of this embodiment are the same as those of the image forming apparatus of the embodiment 1. Accordingly, as regards elements having functions or constitutions identical or corresponding to those of the elements of the image forming apparatus of the embodiment 1, detailed description thereof will be omitted by adding thereto the same reference numerals or symbols s those in the embodiment 1.

FIG. 21 is a perspective view showing a whole constitution of a torque detecting mechanism 300 in this embodiment. Further, FIG. 22 is an exploded perspective view showing constituent members of a drive connection mechanism 320 in this embodiment.

As shown in FIGS. 21 and 22, the torque detecting mechanism 300 includes as a first rotatable member (first member, rotatable member) 311 provided on an input side of a rotational driving force, a second rotatable member (second member, member-to-be-driven) 312 provided coaxially with an rotatably relative to the first rotatable member 311 disposed on an output side of the rotational driving force, a torsion spring 313 as an example of an driving member (elastic member) for applying an urging force (elastic force) along a rotational direction to between the first rotatable member 311 and the second rotatable member 312, and a light blocking/light transmission detecting sensor 131 as an example of a detecting means for detecting a phase difference in rotation angle between the first rotatable member 311 and the second rotatable member 312. Each of the first rotatable member 311 and the second rotatable member 312 is rotatably supported by a rotational shaft 315. The first rotatable member 311 transmits the driving force, inputted to the driving roller 46, to the second rotatable member 312. The second rotatable member 312 rotates the waste toner conveying screw 113 by transmitting the driving force, received from the first rotatable member 311, to the waste toner conveying screw 113. The first rotatable member 311 rotates in an arrow R5 direction in FIGS. 21 and 22. The second rotatable member 312 rotates in an arrow R6 direction in FIGS. 21 and 22. Incidentally, similarly as in the embodiment 1, in this embodiment, a rotational drive direction of the driving roller 46 for driving the belt 41 is one direction, so that the first rotatable member 311 is not reversely rotated. In this embodiment, the drive connection mechanism 320 is constituted by including the first rotatable member 311, the second rotatable member 312, and the torsion spring 313. The detecting sensor 131 may have a constitution similar to those in the embodiment 1 and the embodiment 2.

Parts (a) and (b) of FIG. 23 are perspective views of the first rotatable member 311. Part (a) of FIG. 23 shows a front surface of the first rotatable member 311 (the surface of the first rotatable member 311 on a side opposite from the second rotatable member 312 with respect to a rotational axis direction of the first rotatable member 311), and part (b) of FIG. 23 shows a back surface of the first rotatable member 311 (the surface of the first rotatable member 311 on the second rotatable member 312 side with respect to the rotational axis direction of the first rotatable member 311). Parts (a) and (b) of FIG. 24 are perspective views of the second rotatable member 312. Part (a) of FIG. 24 shows a front surface of the second rotatable member 312 (the surface of the second rotatable member 312 on a side opposite from the first rotatable member 311 with respect to a rotational axis direction of the second rotatable member 312), and part (b) of FIG. 24 shows a back surface of the second rotatable member 312 (the surface of the second rotatable member 312 on the first rotatable member 311 side with respect to the rotational axis direction of the second rotatable member 312). Further, FIG. 25 is a sectional view of the torque detecting mechanism 300 as viewed from the second rotatable member 312 side along the rotational axis direction of the first rotatable member 311. FIG. 26 is a perspective view of the torsion spring 313.

As shown in parts (a) and (b) of FIG. 23, the first rotatable member 311 includes a shaft supporting portion 311b provided at a central portion with an inserting hole 316a into which the rotation shaft 315 is inserted and formed in a cylindrical shape. Further, the first rotatable member 311 includes a disk portion 311d having an outer diameter (diameter) larger than the shaft supporting portion 311b on one side surface of the shaft supporting portion 311b and formed in a disk shape. Further, the first rotatable member 311 includes a flange portion 311e formed so as to constitute a part of the cylindrical shape in a state in which the flange portion 311e stands along an axial direction of the disk portion 311d at an outer peripheral edge of the disk portion 311d. Further, the first rotatable member 311 includes a first rotation angle detecting portion 311a formed, in a sector shape so as to form a predetermined central angle β smaller than a central angle α of the flange portion 311e, toward an outside of the flange portion 311e in a radial direction on an outer peripheral surface of a free end of the flange portion 311e along an axial direction of the flange portion 311e. The first rotatable member 311 integrally includes the shaft supporting portion 311b, the disk portion 311d, the flange portion 311e, and the first rotation angle detecting portion 311a. Further, at a central portion of the disk portion 311d, the inserting hole 316a of the shaft supporting portion 311b is provided in a state of generation. In addition thereto, at the central portion of the disk portion 311d, a cylindrical mounting portion 316 for mounting the torsion spring 313 is provided so as to have the same height (length) as the flange portion 311e along the axial direction. Further, the flange portion 311e is provided with a first locking groove 311c, for locking a linearly formed one end portion 313a of the torsion spring 313, formed in a depth reaching a surface of the disk portion 311d in a position corresponding to one end edge 311a2 of the first rotation angle detecting portion 311a. Further, in one end portion of the flange portion 311e with respect to a circumferential direction of the flange portion 311e, an elastically deformable elastic engaging claw 314 is provided so that a free end portion thereof projects toward the second rotatable member 312 side along the rotational axis direction of the first rotatable member 311. The first rotatable member 311 is mounted rotatably about the rotation shaft 315. The first rotatable member 311 may be constituted as a simple rotatable member, but may also be constituted as a gear for transmitting the rotational driving force by forming a tooth such as a spur tooth at an outer periphery of the shaft supporting portion 311b.

The first rotation angle detecting portion (first flag) 311a of the first rotatable member 311 is for detecting a rotation angle of the first rotatable member 311 by blocking light from the detecting sensor 131.

However, detection of the rotation angle of the first rotatable member 311 does not mean detection of an absolute angle based on a certain position. The detection of the rotation angle of the first rotatable member 311 means that a difference in rotation angle between the first rotatable member 311 and the second rotatable member 312, i.e., rotation angles of the first rotatable member 311 and the second rotatable member 312 are detected as a phase difference. Ordinarily, of the first rotation angle detecting portion 311a formed in the sector shape, one end edge 311al along the rotation direction (circumferential direction) is detected by the detection sensor 131. Incidentally, by the first rotatable member 311, the one end portion 313a of the torsion spring 313 is locked in the neighborhood of the other end edge 311a2 of the first rotation angle detecting portion 311a, so that the other end edge 311a2 of the first rotation angle detecting portion 311a becomes an application point where the rotational force acts on the other end edge 311a2. further, the elastic engaging claw 314 is for maintaining the phase difference between the first rotatable member 311 and the second rotatable member 312 when the rotational load torque acting on the first rotatable member 311 and the second rotatable member 312 becomes the predetermined value or more.

On the other hand, as shown in parts (a) and (b) of FIG. 24, the second rotatable member 312 includes a shaft supporting portion 312b provided at a central portion with an inserting hole 316b into which the rotation shaft 315 is inserted and formed in a cylindrical shape. Further, the second rotatable member 312 includes a second rotation angle detecting portion 312a formed in a sector shape so as to form a predetermined central angle γ toward an outside of a radial direction on one side surface of the shaft supporting portion 312b. Further, the second rotatable member 312 is formed on an outer side surface of the second rotation angle detecting portion 312a and includes a pair of locking projections 312e and 312f disposed opposed to each other with a predetermined gap and provided for locking the other end portion 312a2, of the torsion spring 313, formed linearly. The pair of locking projections 312e and 312f is disposed so that an outer peripheral surface thereof coincides with an outer periphery of the flange portion 311e of the first rotatable member 311 (FIG. 25). Further, the second rotatable member 312 includes an arcuate portion 312d formed small in other diameter in an opening portion of the second rotation angle detecting portion 312a. The arcuate portion 312d is, for example, formed so as to have the same outer diameter as the disk portion 311d of the first rotatable member 311. The second rotatable member 312 includes a first cut-away portion (engaging hole) 314a and a second cut-away portion (engaging hole) 314b formed in the second rotation angle detecting portion 312a and for receiving the elastic engaging claw 314 provided on the first rotatable member 311. The first cut-away portion 314a and the second cut-away portion 314b are disposed along the outer periphery of the flange portion 311e of the first rotatable member 311. The second rotatable member 312 is mounted rotatably about the rotation shaft 315. The second rotatable member 312 may be constituted as a simple rotatable member, but may also be constituted as a gear for transmitting the rotational driving force by forming a tooth such as a spur tooth at an outer periphery of the shaft supporting portion 312b.

The second rotation angle detecting portion (second flag) 312a of the second rotatable member 312 is for detecting a rotation angle of the first rotatable member 311 by blocking light from the detecting sensor 131 similarly as the first rotation angle detecting portion 311a. However, detection of the rotation angle of the second rotatable member 312 does not mean detection of an absolute angle based on a certain position. The detection of the rotation angle of the second rotatable member 312 means that a difference in rotation angle between the second rotatable member 312 and the first rotatable member 311, i.e., rotation angles of the second rotatable member 312 and the first rotatable member 311 are detected as a phase difference. Ordinarily, of the second rotation angle detecting portion 312a formed in the sector shape, one end edge 312al along the rotation direction (circumferential direction) is detected by the detection sensor 131. The second rotation angle detecting portion 312a is formed in a sector shape such that the second rotation angle detecting portion 312a has the central angle γ (for example, 180 degrees or more) larger than the central angle β of the first rotation angle detecting portion 311a. Incidentally, by the second rotatable member 312, the other end portion 313b of the torsion spring 313 is locked in the neighborhood of the one end edge 312a2 of the second rotation angle detecting portion 312a, so that the neighborhood of the one end edge 312a2 of the second rotation angle detecting portion 312a becomes an application point where the rotational force acts thereon.

As shown in FIGS. 21 and 22, the first rotatable member 311 and the second rotatable member 312 are disposed in a state in which the first rotation angle detecting portion 311a and the second rotation angle detecting portion 312a are superposed on each other. The first rotatable member 311 and the second rotatable member 312 are combined with each other in the following manner in an initial state (in a state in which the rotational load torque does not act on between the first rotatable member 311 and the second rotatable member 312). That is, the first rotatable member 311 and the second rotatable member 312 are combined with each other so that a gap with a predetermined angle is formed between the end edge 311a1 of the first rotation angle detecting portion 311a and the end edge 312a1 of a second rotation angle detecting portion 312a. Specifically, in a free state in which the rotational load torque is not applied, the torsion spring 313 is locked so that one end portion 313a thereof is locked in the locking groove 311c of the first rotatable member 311 and the other end portion 313b thereof is locked between the pair of locking projections 312e and 312f of the second rotatable member 312. By this, between the end edge 311a1 of the first rotation angle detecting portion 311a and the end edge 312a1 of the second rotation angle detecting portion 312a, the gap with the predetermined angle is formed. As shown in FIG. 26, the torsion spring 313 is set so that an elastic force (torsional rigidity) along the rotational directions of the first rotatable member 311 and the second rotatable member 312 becomes a predetermined value.

The first rotatable member 311 and the second rotatable member 312 are assembled in the following manner. The rotation shaft 315 is inserted into the inserting hole 316a of the first rotatable member 311, and the torsion spring 313 is mounted to the mounting portion 316 of the first rotatable member 311, and in addition, the one end portion 313a of the torsion spring 313 is locked in the locking groove 311c. Further, the second rotatable member 312 is mounted to the rotation shaft 315 through the inserting hole 316b so that the first rotation angle detecting portion 311a and the second rotation angle detecting portion 312a are superposed on each other. At this time, as shown in FIG. 25, the other end portion 313b of the torsion spring 313 is locked by the pair of locking projections 312e and 312f of the second rotatable member 312. To the first rotatable member 311 and the second rotatable member 312, the rotational driving forces along the arrows R5 and R6 shown in FIG. 21 are imparted, respectively.

An operation principle of the torque detecting mechanism 300 in this embodiment will be described. FIG. 27A and FIG. 27B are front views, of the torque detecting mechanism 300, for illustrating an operation of the torque detecting mechanism 300 in this embodiment. FIG. 27A shows a state in the case where the rotational load torque is smaller than the predetermined value, and FIG. 27B shows a state in the case where the rotational load torque is the predetermined value or more.

As described above, the rotational driving force is inputted to the first rotatable member 311. The rotational driving force inputted to the first rotatable member 311 is transmitted to the second rotatable member 312 through the torsion spring 313. Then, the rotational driving force is outputted from the second rotatable member 312 to the waste toner conveying screw 113. Further, the first rotatable member 311 and the second rotatable member 312 are provided coaxially and rotatably about the rotation shaft 315. Further, to between the first rotatable member 311 and the second rotatable member 312, the elastic force (torsion rigidity) along the rotational direction is imparted by the torsion spring 313. When the first rotatable member 311 is rotationally driven, the rotational driving force is transmitted to the second rotatable member 312 in a state in which the torsional rigidity is applied through the torsion spring 313. At this time, an elastic force corresponding to the rotational load torque acts on the torsion spring 313. By this, the second rotatable member 312 is rotated with a delay to the first rotatable member 311 by a phase difference of rotation angles determined depending on the rotational load torque.

As shown in FIG. 27A and FIG. 27B, the torque detecting mechanism 300 is set so that a predetermined phase difference is initially present between the first rotation angle detecting portion 311a and the second rotation angle detecting portion 312a in a state in which the rotational load torque does not act on between the first rotatable member 311 and the second rotatable member 312. As shown in FIG. 27A, in the state in which the rotational load torque does not act on between the first rotatable member 311 and the second rotatable member 312, the elastic engaging claw 314 of the first rotatable member 311 is received by the first cut-away portion 314a of the second rotatable member 312. Further, as shown in FIG. 27B, when the rotational load torque of the waste toner conveying screw 113 becomes the predetermined value or more and the near full state is detected, the elastic engaging claw 314 of the first rotatable member 311 is rotated while being bent along the rotational axis direction of the first rotatable member 311 and is received by the second cut-away portion 314b of the second rotatable member 312. Further, after the near full state is detected, the elastic engaging claw 314 is maintained in a state in which the elastic engaging claw 314 is received by the second cut-away portion 314b.

Parts (a), (b), and (c) of FIG. 28 are schematic views showing angles each formed by the first rotation angle detecting portion 311a and the second rotation angle detecting portion 312a depending on a magnitude of the rotational load torque, i.e., showing states different in phase. Part (a) of FIG. 28 shows a state in the case where the rotational load torque is smaller than the predetermined value, part (b) of FIG. 28 shows a state immediately before the rotational load torque becomes the predetermined value or more, and part (c) of FIG. 28 shows a state in the case where the rotational load torque is the predetermined value or more.

With an increasing rotational load torque, a difference (phase difference) formed by the first rotation angle detecting portion 311a and the second rotation angle detecting portion 312a increases, and when the difference becomes a predetermined phase difference, a state in which the near full state is detected is formed. Accordingly, the phase difference between the first rotation angle detecting portion 311a and the second rotation angle detecting portion 312a is detected by an exposure time of the detection sensor 131, whereby it becomes possible to detect the rotational load torque. According to this constitution, compared with the case where the rotational load torque is detected by detecting a current flowing through the driving source, there is no need to detect the current flowing through the driving source, so that the rotational load torque can be detected in an arbitrary position where the driving force is transmitted and a degree of freedom of the detecting position can be improved.

The elastic engaging claw 314 of the first rotatable member 311 is moved from the first cut-away portion 314a to the second cut-away portion 314b of the second rotatable member 312 when the near full state is detected. The elastic engaging claw 314 has a shape such that a shift in position (phase) of the second rotatable member 312 relative to the first rotatable member 311 with respect to the rotational direction of the first rotatable member 311 is restricted.

For that reason, when the torque detecting mechanism 300 once changes to the state in which the near full state is detected, the elastic engaging claw 314 is restricted from being demounted from the second cut-away portion 314b and moving to a position where the elastic engaging claw 314 is received by the first cut-away portion 314a. As described above, when the state of the waste toner in the waste toner collecting container 10 is changed by the factor such as the vibration or the like and the conveyance resistance of the waste toner conveying screw 113 lowers, the rotational load torque of the waste toner conveying screw 113 lowers in some instances. In this embodiment, even in this case, the position (phase) of the second rotatable member 312 relative to the first rotatable member 311 with respect to the rotational direction of the first rotatable member 311 is not changed. For that reason, even when the rotational load torque of the waste toner conveying screw 113 is below the predetermined value, the first rotatable member 311 and the second rotatable member 312 maintains the predetermined phase difference, and are restricted from returning to a state in which the rotational load torque is applied before the near full state is detected. That is, even when after the near full state is detected, the state of the waste toner in the waste toner collecting container 10 is changed by the factor such as the vibration or the like and the rotational load torque of the waste toner conveying screw 113 lowers, the torque detecting mechanism 300 is capable of maintaining the state in which the near full state is detected.

Incidentally, in this embodiment, the first rotatable member 311 is provided with the elastic engaging claw stopper 205 as the engaging portion for restricting the change in phase of the second rotatable member 312 by engagement with the second rotatable member 312. However, in place of or in addition to this engaging portion, the second rotatable member 312 may be provided with an engaging portion for restricting the change in phase of the second rotatable member 312 by engagement with the first rotatable member 311.

Thus, in this embodiment, the detecting means is constituted by including the first flag (first rotation angle detecting portion) 311a provided to the first rotatable member 311, the second flag (second rotation angle detecting portion) 312a which is provided to the second rotatable member 312 and of which position relative to the first flag 311a with respect to the rotational direction of the first rotatable member 311 becomes a first position in the case where the second rotatable member 312 is in a first phase (a state in which the rotational load torque is less than the predetermined value and becomes a second position in the case where the second rotatable member 312 is in a second phase (a state in which the rotational load torque is the predetermined value or more), and the sensor (detecting sensor) 131 capable of detecting that the position of the second flag 312a relative to the first flag 311a with respect to the rotational direction of the first rotatable member 311 is in the second position. In this embodiment, the sensor 131 is constituted by including the photosensor for detecting a change in state of at least one of the light blocking and the light transmission of the detection light by the change in relative position between the first flag 311a and the second flag 312a with respect to the rotational direction of the first rotatable member 311. Further, in this embodiment, the restricting means is constituted by including at least one of an engaging portion (elastic engaging claw) 314 which is provided to the first rotatable member 311 and which engages with the second rotatable member 312 in the case where the second rotatable member 312 is in the second phase, and the engaging portion which is provided to the second rotatable member 312 and which engages with the first rotatable member 311 in the case where the second rotatable member 312 is in the second phase.

As described above, also by the constitution of this embodiment, an effect similar to the effect of the constitution of the embodiment 1.

### OTHER EMBODIMENTS

In the above, the present disclosure was described based on specific embodiments, but the present disclosure is not limited to the above-described embodiments.

In general, a mechanical apparatus is provided with various rotatable members, and for example, in the image forming apparatus such as a printer, a copying machine, or a multi-function machine, a rotatable member is used in a process unit necessary for image formation. In the above-described embodiments, as a detection object of which rotational load torque became the predetermined value or more (overload state), the waste toner conveying screw for conveying the waste toner in the waste toner collecting container was described as an example, but the detection object is not limited to the waste toner conveying screw. For example, also, as regards a toner conveying screw of a supplying device for supplying the toner to the developing device and a process means such as the developing roller of the developing device, it is desired in some instances that the overload state thereof is detected. The present disclosure is also applicable to such detection objects.

Further, the waste toner is not limited to the waste toner remaining on the image bearing member after the transfer step. For example, in the image forming apparatus, an operation in which in order to refresh the developer in the developing device, the toner (developer containing toner and a carrier in the case of a two-component developer) is discharged from the developing device is performed in some instances. Further, a toner image (patch) for adjustment which is not transferred onto a recording material is formed on the image bearing member in some instances. The waste toner accommodated in the waste toner collecting container contains the above-described arbitrary toner (which may contain the carrier). Further, the toner removed from the image bearing member is not limited to the toner removed from the intermediary transfer belt, but may also include the toner removed from the photosensitive drum.

Further, in the above-described embodiments, description was made such that the state in which the rotational load torque of the waste toner conveying screw is the predetermined value or more is the near full state of the waste toner collecting container, but for example, the state may also be the full state of the waste toner collecting container.

Further, in the above-described embodiments, description was made such that to the waste toner conveying screw, the driving force from the driving source for rotationally driving the belt (driving roller), but the image forming apparatus may include an individual driving source for rotationally driving the waste toner conveying screw.

Further, in the above-described embodiments, the case where as the detecting sensor, the photosensor is used was described as an example, but as the detecting sensor, for example, a mechanical switch which is turned on/off by a flag may also be used.

Further, torque excess can also be detected in multi-stages by using a plurality of sets of first rotatable members and second rotatable members and a plurality of detecting means. For example, the image forming apparatus includes, in addition to the first rotatable member, the second rotatable member, the detecting means, and the restricting means, a third rotatable member provided coaxially with the first rotatable member and configured to be rotated by transmission of the driving force from the driving source by the second rotatable member; a fourth rotatable member provided coaxially with the first rotatable member and configured to transmit the driving force toward the driven member by being rotated through transmission thereto the driving force from the driving source by the third rotatable member, the fourth rotatable member being rotatable relative to the third rotatable member so that a phase which is a position of the fourth rotatable member relative to the third rotatable member with respect to a rotational direction of the third rotatable member changes from a third phase toward a fourth phase; and another detecting means capable of detecting that the fourth rotatable member is in the fourth phase. The third rotatable member and the fourth rotatable member are configured to as to change the phase of the fourth rotatable member with a change in rotational load torque of the driven member from a third torque, different from the first torque and the second torque, to a fourth torque different from the first torque and the second torque and larger than the third torque so that the third rotatable member and the fourth rotatable member are rotated in a state in which the fourth rotatable member is in the third phase in a case where the rotational load torque of the driven member is the third torque and so that the third rotatable member and the fourth rotatable member are rotated in a state in which the fourth rotatable member is in the fourth phase in a case where the rotational load torque of the driven member is the fourth torque. Further, the image forming apparatus includes another restricting means for restricting that the phase of the fourth rotatable member returns from the fourth phase to the third phase even when the rotational load torque of the driven member lowers from the fourth torque toward the third torque in the case where the phase of the fourth rotatable member changes from the third phase to the fourth phase.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-152770, filed on Sep. 4, 2024, which is hereby incorporated by reference herein in its entirety.

What is claimed is:

1. An image forming apparatus comprising:
a driven member;
a driving source configured to generate a driving force for rotationally driving the driven member;
a first rotatable member configured to be rotated by input of the driving force from the driving source thereto;
a second rotatable member provided coaxially with the first rotatable member and configured to transmit the driving force toward the driven member by being rotated through transmission thereto the driving force from the driving source by the first rotatable member, the second rotatable member being rotatable relative to the first rotatable member so that a phase which is a position of the second rotatable member relative to the first rotatable member with respect to a rotational direction of the first rotatable member changes from a first phase toward a second phase different from the first phase;
detecting means capable of detecting that the second rotatable member is in the second phase; and
restricting means configured to restrict the phase,
wherein the first rotatable member and the second rotatable member are configured so as to change the phase with a change in rotational load torque of the driven member from a first torque to a second torque larger than the first torque so that the first rotatable member and the second rotatable member are rotated in a state in which the second rotatable member is in the first phase in a case where the rotational load torque of the driven member is the first torque and so that the first rotatable member and the second rotatable member are rotated in a state in which the second rotatable member is in the second phase in a case where the rotational load torque of the driven member is the second torque, and
wherein in a case where the phase changes from the first phase to the second phase, even when the rotational load torque of the driven member lowers from the second torque toward the first torque, the restricting means restricts that the phase returns from the second phase to the first phase.

2. The image forming apparatus according to claim 1, wherein
the first rotatable member includes:
a first contact portion for transmitting the driving force to the second rotatable member in contact with the second rotatable member in a case where the second rotatable member is in the first phase, and
a second contact portion for transmitting the driving force to the second rotatable member in contact with the second rotatable member in a case where the second rotatable member is in the second phase,
the second rotatable member includes:
a third contact portion for receiving the driving force from the first rotatable member in contact with the first contact portion in the case where the second rotatable member is in the first phase, and
a fourth contact portion for receiving the driving force from the first rotatable member in contact with the second contact portion in the case where the second rotatable member is in the second phase, and
when the rotational load torque of the driven member changes from the first torque to the second torque, a position of the first rotatable member relative to the second rotatable member in a rotational axis direction of the first rotatable member is changed by a change in position of the first contact portion relative to the third contact portion in the rotational axis direction of the first rotatable member.

3. The image forming apparatus according to claim 2, wherein at least one of the first contact portion and the third contact portion includes a surface inclined with respect to the rotational axis direction of the first rotatable member.

4. The image forming apparatus according to claim 2, wherein at least one of the second contact portion and the fourth contact portion includes a surface substantially parallel to the rotational axis direction of the first rotatable member.

5. The image forming apparatus according to claim 2, wherein
the restricting means includes at least one of
a restricting portion provided to the first rotatable member and for restricting a change in the position of the first rotatable member relative to the second rotatable member in the rotational axis direction of the first rotatable member in contact with the second rotatable member in the case where the second rotatable member is in the second phase, and
a restricting portion provided to the second rotatable member and for restricting a change in the position of the first rotatable member relative to the second rotatable member in the rotational axis direction of the first rotatable member in contact with the first rotatable member in the case where the second rotatable member is in the second phase.

6. The image forming apparatus according to claim 2, further comprising an urging member configured to apply an urging force along the rotational axis direction of the first rotatable member in a direction in which the first rotatable member and the second rotatable member are pressed against each other.

7. The image forming apparatus according to claim 2, wherein
the detecting means includes;
a flag changed in position in interrelation with the change in position of the phase so as to be positioned in a first position in the case where the second rotatable member is in the first phase and so as to be positioned in a second position in the case where the second rotatable member is in the second phase, and
a sensor capable of detecting that the flag is positioned in the second position.

8. The image forming apparatus according to claim 7, wherein the sensor includes a photosensor for detecting at least one of blocking and transmission of detection light by a change in position of the flag.

9. The image forming apparatus according to claim 1, further comprising an urging member configured to apply an urging force to between the first rotatable member and the second rotatable member along the rotational direction of the first rotatable member in engagement with the first rotatable member and the second rotatable member,
wherein the urging member is deformed so that the second rotatable member is positioned relative to the first rotatable member on an upstream side with respect to the rotational direction of the first rotatable member in a case where the second rotatable member is in the second phase than in a case where the second rotatable member is in the first phase.

10. The image forming apparatus according to claim 9, wherein
the detecting means includes;
a flag changed in position in interrelation with the change in position of the phase so as to be positioned in a first position in the case where the second rotatable member is in the first phase and so as to be positioned in a second position in the case where the second rotatable member is in the second phase, and
a sensor capable of detecting that the flag is positioned in the second position.

11. The image forming apparatus according to claim 10, wherein the sensor includes a photosensor for detecting at least one of blocking and transmission of detection light by a change in position of the flag.

12. The image forming apparatus according to claim 10, wherein
the restricting means includes at least one of:
an engaging portion provided to the first rotatable member and for engaging with the second rotatable member in the case where the second rotatable member is in the second phase, and
an engaging portion provided to the second rotatable member and for engaging with the first rotatable member in the case where the second rotatable member is in the second phase.

13. The image forming apparatus according to claim 9, wherein
the detecting means includes:
a first flag provided to the first rotatable member,
a second flag which is provided to the second rotatable member, of which position relative to the first flag in the rotational direction of the first rotatable member in the case where the second rotatable member is in the first phase is a first position, and of which position relative to the first flag in the rotational direction of the first rotatable member in the case where the second rotatable member is in the second phase is a second position, and
a sensor capable of detecting that the position of the second flag relative to the first flag in the rotational direction of the first rotatable member is the second position.

14. The image forming apparatus according to claim 13, wherein the sensor includes a photosensor for detecting at least one of blocking and transmission of detection light by a change in relative position between the first flag and the second flag in the rotational direction of the first rotatable member.

15. The image forming apparatus according to claim 13, wherein
the restricting means includes at least one of:
an engaging portion provided to the first rotatable member and for engaging with the second rotatable member in the case where the second rotatable member is in the second phase, and
an engaging portion provided to the second rotatable member and for engaging with the first rotatable member in the case where the second rotatable member is in the second phase.

16. The image forming apparatus according to claim 1, further comprising:
a third rotatable member provided coaxially with the first rotatable member and configured to be rotated by transmission of the driving force from the driving source by the second rotatable member;
a fourth rotatable member provided coaxially with the first rotatable member and configured to transmit the driving force toward the driven member by being rotated through transmission thereto the driving force from the driving source by the third rotatable member, the fourth rotatable member being rotatable relative to the third rotatable member so that a phase which is a position of the fourth rotatable member relative to the third rotatable member with respect to a rotational direction of the third rotatable member changes from a third phase toward a fourth phase different from the third phase; and
another detecting means capable of detecting that the fourth rotatable member is in the fourth phase,
wherein the third rotatable member and the fourth rotatable member are configured so as to change the phase of the fourth rotatable member with a change in rotational load torque of the driven member from a third torque, different from the first torque and the second torque, to a fourth torque different from the first torque and the second torque and larger than the third torque so that the third rotatable member and the fourth rotatable member are rotated in a state in which the fourth rotatable member is in the third phase in a case where the rotational load torque of the driven member is the third torque and so that the third rotatable member and the fourth rotatable member are rotated in a state in which the fourth rotatable member is in the fourth phase in a case where the rotational load torque of the driven member is the fourth torque, and
the third rotatable member and the fourth rotatable member includes another restricting means for restricting that the phase of the fourth rotatable member returns from the fourth phase to the third phase even when the rotational load torque of the driven member lowers from the fourth torque toward the third torque in a case where the phase of the fourth rotatable member changes from the third phase to the fourth phase.

17. The image forming apparatus according to claim 1, further comprising:
an image forming portion configured to form a toner image;
an endless belt onto which the toner image formed by the image forming portion is transferred;
a cleaning portion configured to remove toner from the belt;
a waste toner collecting container configured to accommodate the toner removed from the belt by the cleaning portion; and
a waste toner conveying member configured to convey the toner in the waste toner collecting container,
wherein the driven member is the waste toner conveying member.

18. The image forming apparatus according to claim 17, wherein the second torque is a rotational load torque of the waste toner conveying member in a case where an amount of the toner accommodated in the waste toner collecting container reaches a predetermined amount.

19. The image forming apparatus according to claim 17, wherein a unit including the belt, the cleaning portion, the waste toner collecting container, the waste toner conveying member, the first rotatable member, and the second rotatable member is detachably mountable to a main assembly of the image forming apparatus.
